(19) United States
(12) Patent Application Publication
(10) Pub. No.: US 2008/0304090 A1
(43) Pub. Date: Dec. 11, 2008

(54) INFORMATION PROCESSING APPARATUS AND INFORMATION PROCESSING PROGRAM

(75) Inventor: Takafumi SHIMMOTO, Kanagawa (JP)

Correspondence Address: COOPER & DUNHAM, LLP, 1185 AVENUE OF THE AMERICAS, NEW YORK, NY, 10036, US

(73) Assignee: Ricoh Company, Ltd., Tokyo (JP)

(21) Appl. No.: 12/041,891

(22) Filed: Mar. 4, 2008

(30) Foreign Application Priority Data
Mar. 16, 2007 (JP) 2007-067972

(51) Int. Cl. G06F 3/12

(52) U.S. Cl. 358/1.13

(57) ABSTRACT

An information processing apparatus capable of adding or deleting an application without modifying other components is disclosed. A disclosed Multi Function Peripheral includes an application layer having plural applications each executing a process with settings unique to each application, plural jobs each having settings common to the applications and representing a receipt of a request for the application process with respect to the corresponding application, and an application control layer collectively managing the plural jobs and issuing an instruction to execute the application process received by the job to the application capable of executing the application process received by the job based on managing the plural jobs.

### BACKGROUND OF THE INVENTION

1. Field of the Invention

The present invention generally relates to an information processing apparatus and an information processing program for executing plural applications.

2. Description of the Related Art

Recently, with the improvement of computer technologies, an apparatus performing various functions has becoming popular. As an example of such an apparatus, there is a multi function peripheral (MFP). Though a printer, a copier, and a facsimile function are provided each in a separate chassis, an MFP provides the functions in the chassis of the MFP.

Generally, an MFP further includes a display section, a printing section, an imaging section, and three kinds of software corresponding to a printer, a copier, and a facsimile machine, so as to be operated as a printer, a copy, and a facsimile machine, respectively by switching the software.

However, in an MFP, when software (including a dedicated OS) corresponding to each application is separately provided, a large amount of time may be required to develop each software package.

To solve the problem, Patent Document 1 provides a technology in which an MFP includes an operating system and a program that runs on the OS and that is accessed from plural applications to be commonly used by the applications. Because of the software configuration, it becomes possible to develop software for an MFP effectively.

Patent Document 1: Japanese Patent Application Publication No. 2002-84383

However, the concept of the technology described in Patent Document 1 has resulted in that only the part of the existing technologies that can be shared in software is designed as such software. Because of this feature, in an MFP designed by employing the technology described in Patent Document 1, when a new application is required to be developed to add into the MFP, it is necessary to develop or modify the shared program as well. As a result, unfortunately, the benefit of this technology that provides effective development as described above may not be realized.

### SUMMARY OF THE INVENTION

The present invention is made in light of the above problems and may provide an information processing apparatus and an information processing program in which applications can be added and deleted easily.

According to a first aspect of the present invention there is provided an information processing apparatus including plural applications each executing an application process based on settings different from those of the other applications, plural jobs each having settings common to all the applications and representing a receipt of a request for the application process with respect to the corresponding application, and an application control section collectively managing the plural jobs and issuing an instruction to execute the application process received by the job to the application capable of executing the application process received by the job based on the managing plural jobs.

According to a second aspect of the present invention there is provided an information processing apparatus according to the first aspect, wherein the application control section issues the instruction to execute the application process using a common command to each of the applications, and each of the applications executes the application process in accordance with the common command.

According to a third aspect of the present invention there is provided an information processing apparatus according to the second aspect, wherein the application control section includes application managing information that includes application information for identifying each of the applications, and the application control section issues an instruction using the common command to an application identified by the application information included in the application managing information.

According to a fourth aspect of the present invention there is provided an information processing apparatus according to the first aspect, wherein each of the applications includes an application job including operating conditions that are unique to each of the applications and that are received settings for executing the application process, and the application control section collectively manages the jobs associated with the corresponding application jobs of the corresponding applications.

According to a fifth aspect of the present invention there is provided an information processing apparatus according to the fourth aspect, wherein each of the applications generates an application job upon receiving a request for the application process, and issues a request to register the job to the application control section. The application control section generates the job upon receiving the request to register the job from the application, and associates the generated job with the application job of the application that issued the request for the registration.

According to a sixth aspect of the present invention there is provided an information processing apparatus according to the fourth or the fifth aspect, wherein the application control section further includes a queue including the collectively managed jobs, and based on the order of jobs arranged in the queue, issues an instruction to the application capable of executing the application process received by each job to execute the application process received by the job.

According to a seventh aspect of the present invention there is provided an information processing apparatus according to the sixth aspect, wherein the application control section further includes a schedule managing section for changing the order of jobs arranged in the queue.

According to an eighth aspect of the present invention there is provided an information processing apparatus according to the second aspect, further including a shared service section providing a resource to control hardware for the application.

According to a ninth aspect of the present invention there is provided an information processing apparatus according to the eighth aspect, wherein the application issues a request to use a resource along with providing user information of a user using the application to the shared service section; the shared service section includes rights management information indicating whether a user has a right to use a resource; the shared service section further includes a rights determination section that upon receiving a request to use a resource from the application, determines whether a user identified by the user information has a right to use the resource based on the rights management information; and when it is determined that the user has a right to use the resource, the shared service section provides the resource for the application.

According to a tenth aspect of the present invention there is provided an information processing apparatus according to any one of the first through the ninth aspects, wherein the application includes processing information representing logic for executing the application process unique to each application, and an interface to be used when a configuration other than that of the information processing apparatus is to be used upon the execution of the process based on the processing information.

According to an eleventh aspect of the present invention there is provided an information processing program for causing a computer to function as means for executing plural applications each executing an application process representing a process performed with settings unique to each application. The program includes plural jobs each having settings common to all the applications and representing a receipt of a request for the application process with respect to the corresponding application, and application control means collectively managing the plural jobs and issuing an instruction to execute the application process received by the job to the application capable of executing the application process received by the job based on managing the plural jobs.

According to a twelfth aspect of the present invention there is provided an information processing program according to the eleventh aspect, wherein the application control means issues the instruction to execute the application process using a common command to each of the applications.

According to a thirteenth aspect of the present invention there is provided an information processing program according to the twelfth aspect, wherein the application control means uses an application managing information that includes application information for identifying each of the applications, and issues an instruction using the common command to an application identified by the application information included in the application managing information.

According to a fourteenth aspect of the present invention there is provided an information processing program according to the eleventh aspect, wherein the application control means collectively manages the jobs each associated with the corresponding application job that is possessed by each of the applications and that includes operating conditions unique to each application.

According to a fifteenth aspect of the present invention there is provided an information processing program according to the fourteenth aspect, wherein the application control means generates the job upon receiving the request to register the job from the application, and associates the generated job with the application job possessed by the application that issued the request for the registration.

According to a sixteenth aspect of the present invention there is provided an information processing program according to the fourteenth or the fifteenth aspect, and the application control means further includes a queue containing the collectively managed jobs, and based on the order of jobs arranged in the queue, issues an instruction to the application capable of executing the application process received by each job to execute the application process received by the job.

According to a seventeenth aspect of the present invention there is provided an information processing program according to the sixteenth aspect, wherein the application control means further includes a schedule managing section for changing the order of jobs arranged in the queue.

According to an eighteenth aspect of the present invention there is provided an information processing program according to any one of the eleventh through the seventeenth aspects, further including a shared service means providing a resource to control hardware for the application that received the instruction to execute the process from the application control means.

According to a nineteenth aspect of the present invention there is provided an information processing program according to the eighteenth aspect, wherein the shared service means further includes a rights determination means that upon receiving a request to use a resource along with user information for identifying a user from the application, determines whether a user identified by the user information has a right to use the resource using rights management information to determine whether a user has a right to use a resource, and when it is determined that the user has a right to use the resource; the shared service means provides the resource for the application.

According to a twentieth aspect of the present invention there is provided an information processing program according to any one of the eleventh through the nineteenth aspects, wherein the application includes processing information representing logic for executing the application process unique to each application, and an interface used when a configuration other than that of the information processing apparatus is used upon the execution of the process by the processing information.

According the first through the seventh aspects of the present invention, an application can be added and deleted without modifying the application control section.

According the eighth and ninth aspects of the present invention, since a shared service section provides a resource used by an application, the redundancy of applications can be better controlled.

According the tenth aspect of the present invention, since the application includes processing information and an interface, the redundancy of applications can be better controlled.

According the eleventh through the seventeenth aspects of the present invention, an application can be added and deleted without modifying the application control section.

According the eighteenth and the nineteenth aspects of the present invention, since a shared service section provides a resource used by an application, the redundancy of applications can be better controlled.

According the twentieth aspect of the present invention, since the application includes processing information and an interface, the redundancy of applications can be better controlled.

### BRIEF DESCRIPTION OF THE DRAWINGS

Other objects, features, and advantages of the present invention will become more apparent from the following descriptions when read in conjunction with the accompanying drawings, in which:

FIG. 1 is a block diagram showing a configuration of a Multi Function Peripheral (MFP) according to an embodiment of the present invention;

FIG. 2 is a drawing showing a configuration of the copy application shown in FIG. 1;

FIG. 3 is a drawing showing a table configuration of the application management table shown in FIG. 1;

FIG. 4 is a drawing showing a relationship between each user JOB in the user JOB queue in the application layer and the corresponding application JOB in the application layer;

FIG. 5 is a drawing showing the control performed between a user JOB and a copy JOB;

FIG. 6 is a drawing showing commands that can be used when the application control layer controls each application in the application layer;

FIG. 7 shows the class configurations of the user JOB and the copy JOB used in an MFP;

FIG. 8 is a transition diagram showing the JOB statuses changed by each operation of the user JOB;

FIG. 9 is a drawing showing a relationship between the application layer and the application shared service layer;

FIG. 10 is a rights management table referred to in FIG. 1;

FIG. 11 shows the class configuration of the user information received from an application;

FIG. 12 is a flowchart showing a process performed by an application in the application layer from the receipt of an execution request to the execution of the request;

FIG. 13 is a flowchart showing a process performed by the application control layer from the receipt of the registration request of the user JOB from the application to the transmission of an instruction of the execution to the application;

FIG. 14 is a sequence diagram showing the processes when a copy application receives a request to execute a copy process from the user interface layer;

FIG. 15 is a sequence diagram showing the processes when a copy application receives a request to execute a copy process and then a printer application receives a request to execute a printer process from the user interface layer;

FIG. 16 is a diagram schematically showing schedule management based on the priority level performed by the schedule management section;

FIG. 17 is a flowchart showing the processes when JOBs to be executed are collectively stopped in an MFP according to an embodiment of the present invention;

FIG. 18 is a sequence diagram showing processes when the user interface layer issues an instruction to collectively stop the execution of the JOBs;

FIG. 19 is a flowchart showing processes to display a list of JOBs in an MFP according to an embodiment of the present invention;

FIG. 20 is a diagram showing an exemplary JOB list displayed by the user interface layer;

FIG. 21 is a diagram showing an example of detailed information of the user JOB displayed by the user interface layer;

FIG. 22 is a sequence diagram showing processes after the user interface layer receives a request to display a JOB list;

FIG. 23 is a flowchart showing processes in which the application shared service layer determines whether there is a right to use a hardware resource when an application requests to use the hardware;

FIG. 24 is a sequence diagram showing processes when the application control layer issues an instruction to execute a copy JOB;

FIG. 25 is a block diagram showing a hardware configuration of the MFP of an embodiment;

FIG. 26 is a block diagram showing a configuration of software group in a conventional MFP; and

FIG. 27 is a drawing schematically showing the service layer and each of the applications in a conventional MFP.

### DETAILED DESCRIPTION OF THE PREFERRED EMBODIMENTS

In the following, an information processing apparatus and an information processing program according to an exemplary embodiment of the present invention is described with reference to the accompanying drawings.

As an embodiment of the present invention, a Multi Function Peripheral (called an “MFP”) is described. An MFP 100 is an information processing apparatus that collectively includes a copy function, a facsimile (FAX) function, a printing function, a scanner function, and a function of distributing an input image (a draft image read by the scanner function and an image input by a printer or the FAX function).

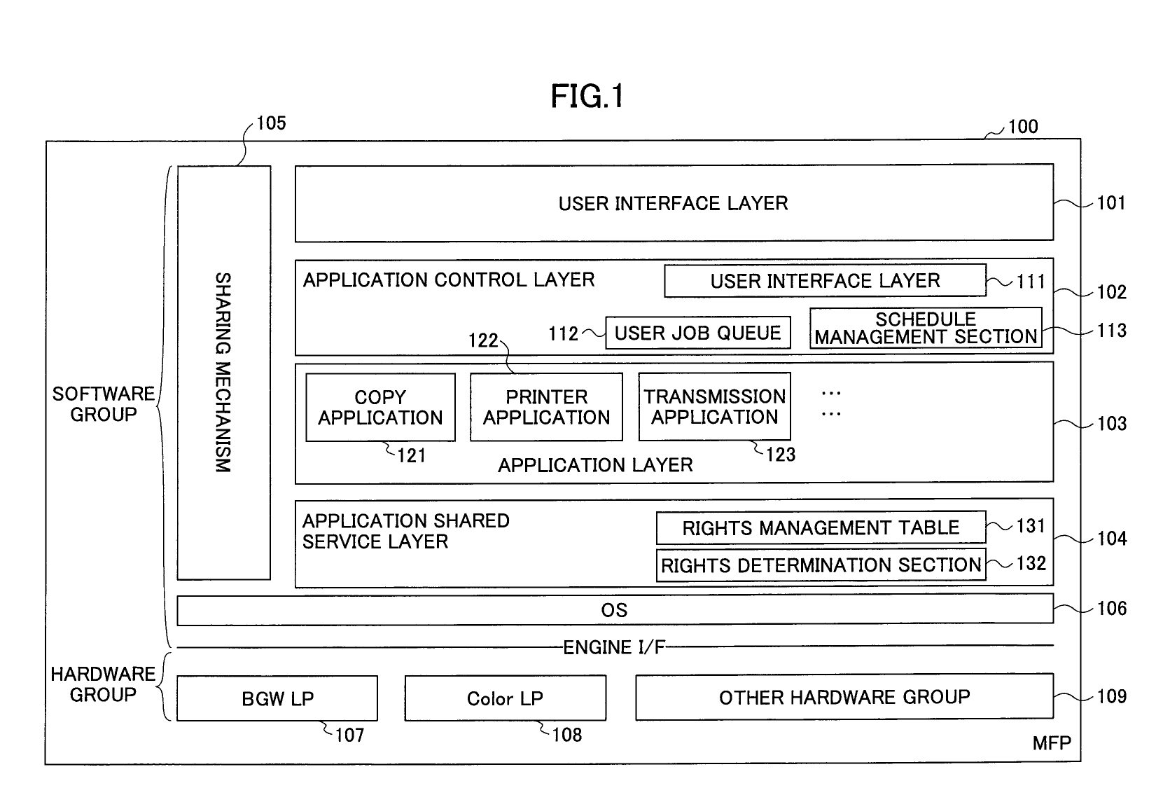

FIG. 1 is a block diagram showing a configuration of the MFP 100 according to an embodiment of the present invention. As shown in FIG. 1, the MFP 100 includes a user interface layer 101, an application control layer 102, an application layer 103, an application shared service layer 104, a sharing mechanism 105, an OS 106, a black and white line printer (B&W LP) 107, a color line printer (Color LP) 108, and an other hardware group 109 that includes a scanner, a facsimile machine, and the other devices.

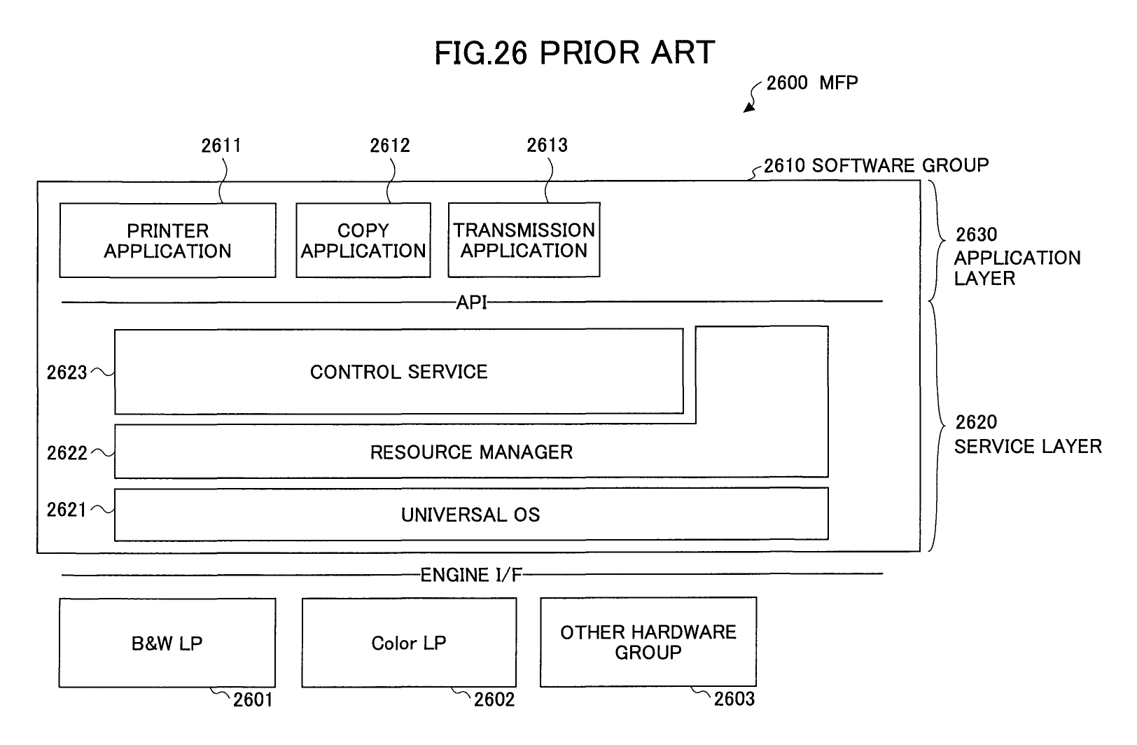

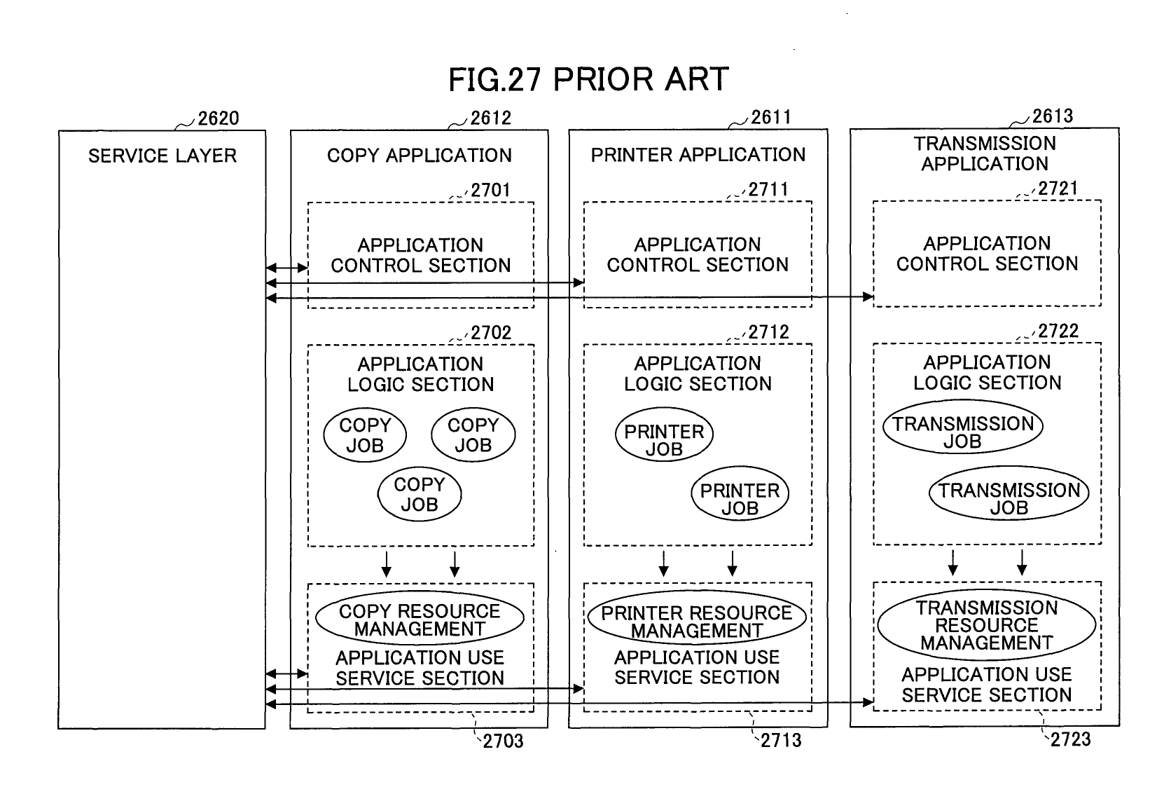

Next, reasons why the MFP 100 has the layer configuration as shown in FIG. 1 are described with reference to FIGS. 26 and 27. FIG. 26 shows a software configuration used in a conventional MFP 2600.

As shown in FIG. 26, the conventional MFP 2600 includes a black and white line printer 2601, a color line printer 2602, the other hardware group 2603 such as a scanner and a facsimile machine, and a software group 2610. Further, the software group 2610 includes an application layer 2630 and a service layer 2620.

The service layer 2620 includes a control service 2623, a resource manager 2622, and an operating system (hereinafter referred to as “OS”) 2321. The control service 2623 interprets a processing request from the application layer 2630 and generates an acquiring request for a hardware resource. The resource manager 2622 manages one or more hardware resources and mediates the acquiring request from the control service 2623.

The service layer 2620 further includes an application programming interface (hereinafter referred to as “API”) that provides previously defined functions that enable reception of processing requests from the application layer 2630.

The OS 2621 is an operating system such as UNIX (Registered trademark) and executes in parallel each software of the service layer 2620 and the application layer 2630 as a process.

Further, the application layer 2630 executes processing unique to each user service of image forming processes such as printing, copying and transmitting. The application layer 2630 includes a printer application 2611, a copy application 2612, and a transmission application 2613. The printer application 2611 is an application for a printer and includes Page Description Language (PDL, PCL) and PostScript (PS). The copy application 2612 is an application for a copier. The transmission application 2613 is an application for network transmission. Next, the data transmission in the software group 2610 in the conventional MFP 2600 is described.

FIG. 27 is a conceptual diagram showing the service layer 2620 and each of the applications in the conventional MFP 2600. As shown in FIG. 27, the copy application 2612 includes an application control section 2701, an application logic section 2702, and an application use service section 2703.

Further, the printer application 2611 includes an application control section 2711, an application logic section 2712, and an application user service section 2713. The transmission application 2613 includes an application control section 2721, an application logic section 2722, and an application user service section 2723. It should be noted that the processes performed by the printer application 2611 and the transmission application 2613 are the same as those performed by the copy application 2612, so that the description of the processes performed by the printer application 2611 and the transmission application 2613 are omitted.

The application control section 2701 controls the application. Further, the application logic section 2702 stores the logic for performing the copying. The logic unique to the application is processed in the application. Further, the application use service section 2703 manages the resource for the copying and includes an interface with the service layer 2620. Since the application control section 2701 and the application use service section 2703 transmit data with the service layer 2620, the application control section 2701 and the application use service section 2703 have high dependency on the service layer 2620.

Further, the application logic section 2702 holds the copy process request received from a user as a copy JOB, and requests the application user service section 2703 to execute the copy process based on the copy JOB.

As described above, in a conventional MFP 2600, each application holds and manages the jobs of the application in its application logic section. As a result, the sequence of executing the jobs is not controlled among the application logic sections of the applications. Because of this feature, when, for example, a copy process is requested of the copy application 2612 for plural times and then a printer process is requested of the printer application 2611, it is not possible to request to change the priority to perform the printer process before the copy processes are executed.

Further, when all the jobs that the MFP 2600 receives are to be stopped, it is necessary that the service layer 2620 requests each application to stop receiving the jobs and executing the jobs. Further, when the MFP 2600 displays the list of jobs received by the MFP 2600, since each application holds the corresponding jobs, it is necessary to request each application to transmit the jobs, and it is necessary that each application to change the format of the job list so that the service layer can recognize the format of the job list.

Further, in each application of the MFP 2600, the application user service section manages the resource used for the application. An example of the resource that is managed by the application user service section includes the access control. Namely, as more and more attention is paid to security matters, the number of requests for checking whether a user can use the hardware resource is increasing. To respond to this request, the application user service section is arranged to check whether the resource can be used. However, this type of checking needs to be implemented in each application, therefore the development cost is increased. It should be noted that, in this description, the term “hardware resources” refers to the software used for controlling the hardware, but the “hardware resource” may be hardware in other examples.

Further, in the MFP 2600, the service layer 2620 has high dependency with each application because, for example, the service layer 2620 frequently communicates with the application control sections and the application user service sections. Because of this feature, when a new application is added to the MFP as a new function, the service layer 2620 is required to be modified. As a result, the development process is increased due to the modification. Namely, there arises a problem that the advantage of reducing the development process by using a program that can be shared is no longer evident when a new function is developed and added in the MFP 2600.

The main cause of the problems is that, in the MFP 2600, the API common to the applications is shared in the service layer only, and the concept of the modification is not adaptable to an expansion of a new function. Because of the feature, in the MFP 2600, the technology is successful in that the development efficiency of an existing application is be improved by sharing an existing resource, but, unfortunately, the problem is that the technology cannot reduce the development process when a new function or a new solution is added to the MFP 2600.

It should be noted that this kind of problem is not limited to an MFP, and is commonly applicable to any image information processing apparatus in which plural image processing applications can be implemented.

To solve the problems, the MPF 100 according to an embodiment of the present invention is designed to have the configuration as shown in FIG. 1. Next, each element of the MFP 100 is described. As described above, the MFP 100 includes the B&W LP 107, the color LP 108, and the other hardware group 109 including a scanner and a facsimile machine.

The user interface layer 101 performs a display process so that data are displayed on a display section (not shown) and a receipt process of input data from a user. The user interface layer 101 outputs the received input data to the application control layer 102 or the application layer 103, or performs a display process to display the information input from the application control layer 102 or the application layer 103 on the display section.

The application layer 103 includes the software for performing the functions of MFP 100 including printer, copier, and transmission functions. The application layer 103 includes a copy application 121, a printer application 122, and a transmission application 123. The copy application 121 is an application for a copier. The printer application 122 is an application for a printer and includes Page Description Language (PDL, PCL) and PostScript (PS). The transmission application 123 is an application for network transmission.

Since each application in the application layer 103 is placed under the control of the application control layer 102, a prescribed rule (I/F) is established when each application is implemented. Because of this feature, it is possible to control any application in the application layer 103 from the application control layer 102. The prescribed rule is described below.

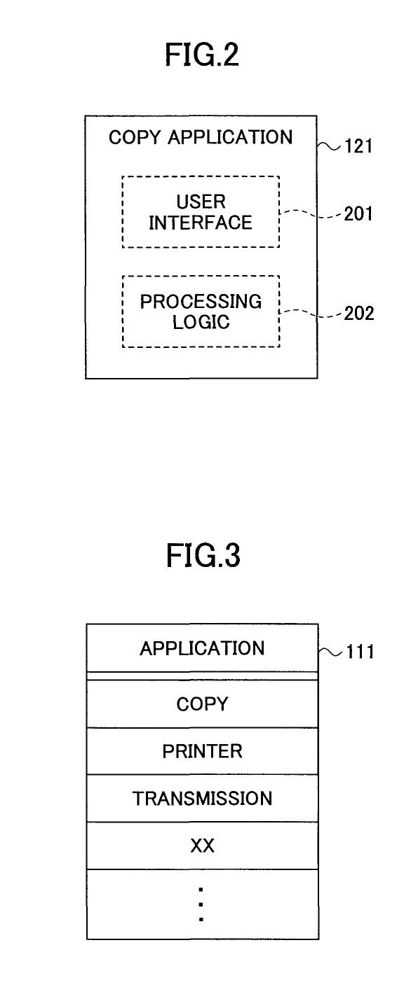

Next, by referring to the copy application 121, the configuration of the software in the application is described. FIG. 2 shows a software configuration of the copy application 121. As shown in FIG. 2, the copy application 121 includes a user interface 201 and processing logic 202. The processing logic 202 contains the logic to perform copying. An instruction to perform processing from the application control layer 102 described below is transmitted to the processing logic 202.

The user interface 201 is for using the processing logic 202. Further, the user interface 201 includes the information for displaying a menu on the display section, the menu being necessary for a copy process. As described above, when the processing logic 202 is added, the user interface for using the processing logic 202 can be added.

Because of the feature, in each application, the dependency on the other modules is reduced. Therefore, it becomes easier to add and delete an application.

Further, when the processing logic 202 receives an instruction to execute a process through the user interface layer 101, the processing logic 202 generates an application JOB corresponding to the process. It is assumed that the application JOB includes operating conditions set by a user set for performing the process.

Then, the processing logic 202 sends a request to the application control layer 102 so that the application control layer 102 generate a user JOB associated with the generated application JOB. The application JOB and the user JOB are described below. Though an example of the copy application 121 is described as an exemplary embodiment of the present invention, the descriptions of other applications are omitted since the other applications have a similar configuration as that of the copy application 121.

The application control layer 102 includes an application management table 111, a user JOB queue 112, a schedule management section 113, and controls each application included in the application layer 103. For example, the application control layer 102 collectively controls the schedule management of the jobs, the stopping of receiving the jobs, and the display of the job list as a system.

FIG. 3 shows a table configuration of the application management table 111. As shown in FIG. 3, the application management table 111 holds the application identification information of the application that is added in the application layer 103. Based on the application identification information, the application layer 103 identifies and controls the applications stored in the application layer 103. When an application is added in the application layer 103, the application identification information for identifying the added application is added in the application management table 111. By doing this, the application layer 102 can recognize the added application.

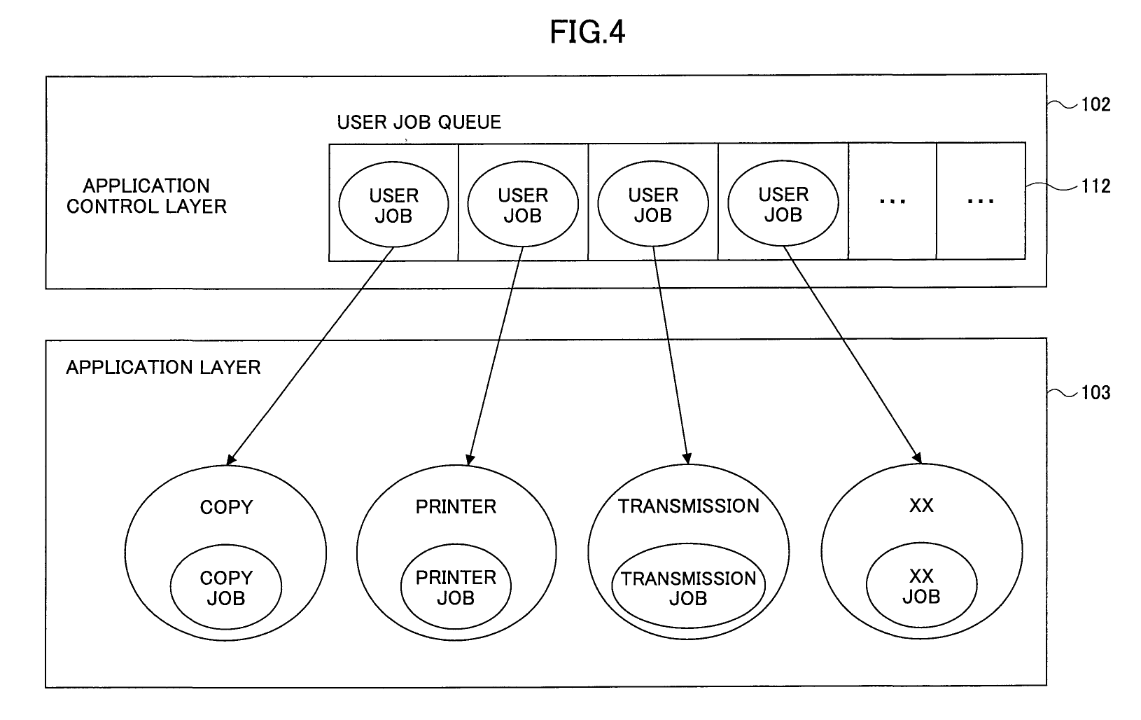

The user JOB queue 112 is a queue for managing requests unit (user JOB) received from users. FIG. 4 is a drawing schematically showing a relationship between the user JOB queue 112 in the application control layer 102 and each application JOB of the corresponding application in the application layer 103. As shown in FIG. 4, each user JOB in the user JOB queue is associated with the corresponding application JOB (for example, a copy JOB, a printer JOB, a transmission JOB, and an XX JOB) of the corresponding application in the application control layer 102.

Further, it is assumed that the user JOB is a JOB that indicates a request for a process received from a user and does not include any settings (for example, operating conditions) depending on each application. As a result, the user JOB has very low dependency on each application.

The application layer 102 executes starting with the first user JOB in the user JOB queue 112. Then, the application JOB associated with the executed user JOB is called to execute the process of the called application JOB.

Namely, the application control layer 102 holds the user JOBs in the user JOB queue 112, and can control the execution of all the applications in the application layer 103 by controlling the execution of the user JOBs.

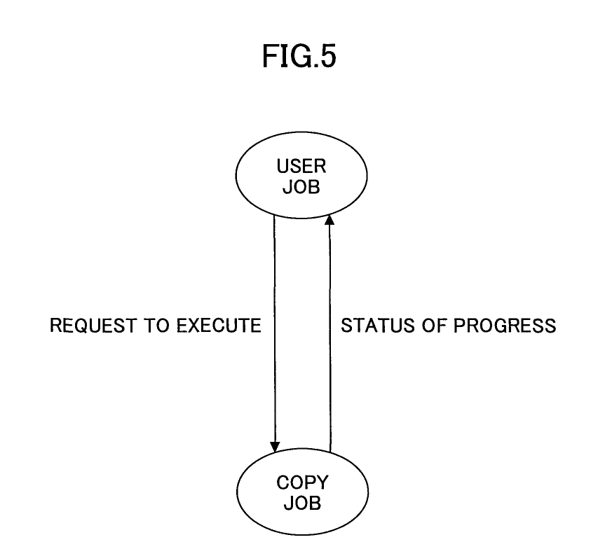

FIG. 5 shows the control between the user JOB and the copy JOB. As shown in FIG. 5, the user JOB sends a command for the execution of the copy JOB to the copy JOB. After the execution of the copy JOB is started, the copy JOB informs the user JOB of the status of the execution of the copy JOB. Because of this arrangement, the user JOB can control the execution of the application JOBs and know the status of the execution of the application JOBs. Next, the commands issued by the application control layer 102 for controlling the execution of the applications are described.

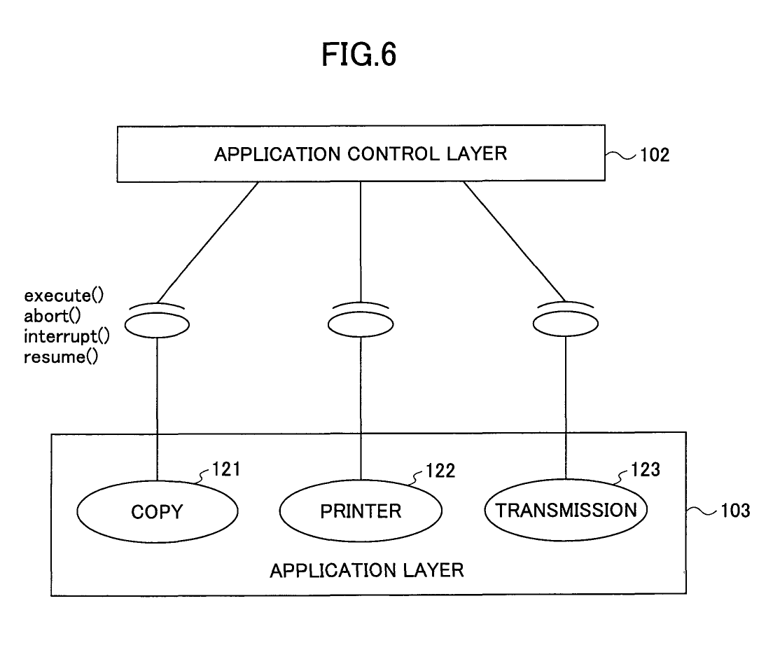

FIG. 6 shows the commands that are issued by the application control layer 102 and that can be used for the control of each application in the application layer 103. As shown in FIG. 6, each application in the application layer 103 is designed so as to be controlled by four commands, “execute( )” “abort( )”, “interrupt( )”, and “resume( )”, as the prescribed rule (I/F).

Because of this arrangement, the application control layer 102 according to an embodiment of the present invention can control any application in the application layer 103 by using the unified commands.

Therefore, even when an application in the application layer 103 is added or deleted, the commands that are used by the application layer 102 and that are used for controlling the execution of the applications JOBs do not change, thereby enabling the easy addition/deletion of an application.

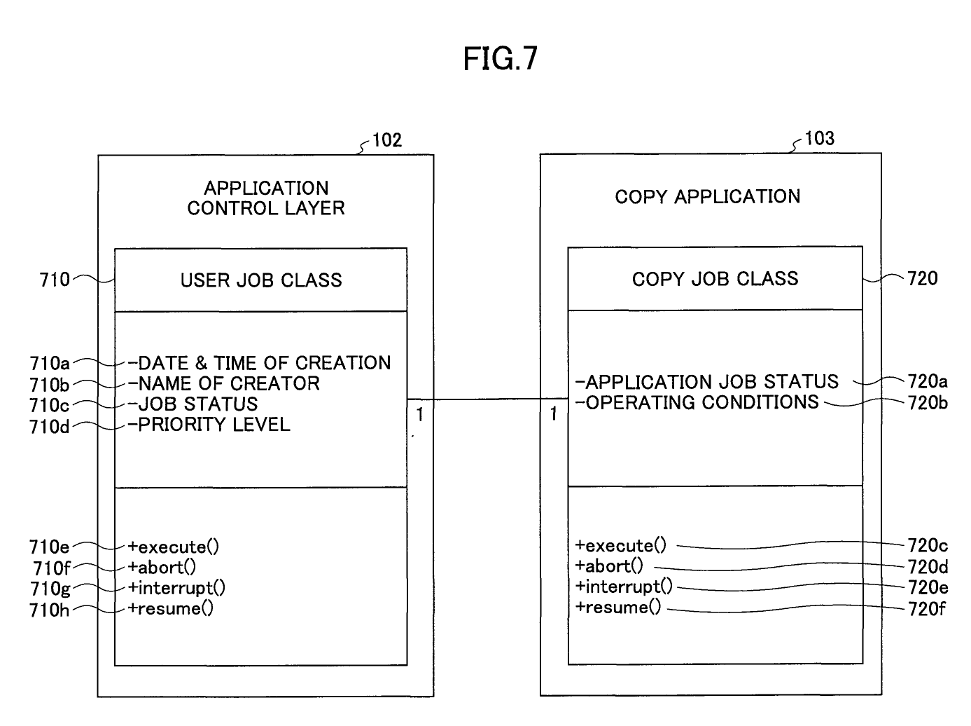

Next, the class configurations of the user JOB and the copy JOB according to an embodiment of the present invention are described. FIG. 7 is a drawing showing the class configurations of the user JOB and the copy JOB used in the MFP 100. As shown in FIG. 7, the application control layer 102 includes a user JOB class 710, and the copy application 121 includes a copy JOB class 720. It should be noted that any other application also includes its JOB class, and the configuration of the JOB class is the same as that of the copy JOB class 720; therefore the description of the other application is omitted.

The rectangle indicating each class has three sections. These sections are called (from upper to lower) a name section indicating the class name, an attribute section indicating the data (attributes) in the class, and an operation section indicating the processes (operations) in the class. For example, the name section of the rectangular indicating the user JOB 710 indicates that the class name of this class is “user JOB”; the attribute section indicates that the attributes of this class are “Date and time of creation”, “Name of creator”, “JOB status”, and “Priority level”; and the operation section indicates that the operations of the class are “execute( )”, “abort( )”, “interrupt( )”, and “resume( )”.

As described above, each class includes the attribute section for storing the data (attributes), and the operation section for storing the processes (operations) for reading and writing the attributes. These classes are included as a part of the program of the application layer 103 or the copy application 121. When a request for processing is received from a user, each class is held in a prescribed area of the memory section (not shown) and the values appropriate to the received process are set for each data element (attribute) included in the attribute section.

When a symbol “−” is added to the left-hand side of the element such as attribute or operation of a class, it indicates that the attribute and the operation are not open to the other classes. On the other hand, when a symbols “+” is added, it indicates that the attribute and the operation are open to the other classes.

Next, each class in FIG. 7 is described. The user JOB class 710 controls the information of the user JOB. More specifically, the user JOB class 710 includes the attributes of “Date and time of creation” 710a, “Name of creator” 710b, “JOB status” 710c, and “Priority level” 710d; and the operations of “execute( )” 710e, “abort( )” 710f, “interrupt( )” 710g, and “resume( )” 710h. The attributes described above of the user JOB class 710 are exemplary attributes that are included by each application. Namely, the attributes held by each user JOB class may be any attribute that is not dependent on a specific application. By the arrangement where each user JOB class 710 has such attributes, an amendment of the user JOB class 710 is not necessary even when an application is added or deleted.

The “Date and time of creation” 710a stores the date and time when the process is received from a user. The “Name of creator” 710b stores the user ID of a user who sends the process. The “JOB status” 710c stores the status of a user JOB. Details of the “JOB status” 710c are described below. The “Priority level” 710d stores the priority level assigned to a user to execute the process of the user JOB.

The command “execute( )” 710e changes the above “JOB status” 710c, and calls the “execute( )” 720c of the associated copy JOB object.

The command “abort( )” 710f changes the above “JOB status” 710c, and calls the “abort( )” 720d of the associated copy JOB object.

The command “interrupt( )” 710g changes the above “JOB status” 710c, and calls the “interrupt( )” 720e of the associated copy JOB object.

The command “resume( )” 710h changes the above “JOB status” 710c, and calls the “resume( )” 720f of the associated copy JOB object.

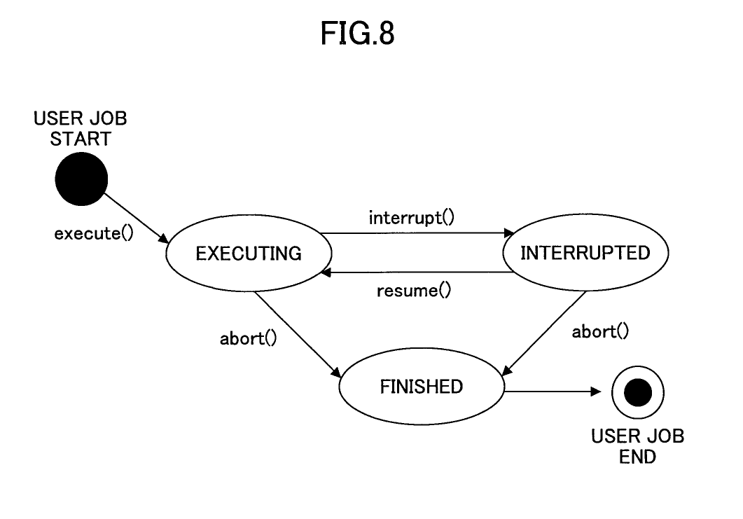

FIG. 8 is a transition diagram showing the changes of the JOB status 710c by each operation. As shown in FIG. 8, the JOB status 710c is changed its status to “Executing”, “Interrupted”, or “Finished” by each operation.

Referring back to FIG. 7, the copy JOB class 720 manages the information of the copy JOB. More specifically, the copy JOB class 720 includes the attributes of an “Application JOB status” 720a and “Operating conditions” 720b; and the operations of “execute( )” 720c, “abort( )” 720d, “interrupt( )” 720e, and “resume( )” 720f.

The “Application JOB status” 720a stores the status of the application JOB. The “Operating conditions” 720b stores, for example, the conditions set for executing the application JOB.

The command “execute( )” 720c executes the process of the copy JOB (application JOB). The command “abort( )” 720d aborts the executing process of the copy JOB.

The command “interrupts” 720e interrupts the execution of the copy JOB. The command “resume( )” resumes the interrupted execution of the copy JOB.

Further, the multiplicity of the user JOB class 710 is “1”, and the multiplicity of the copy JOB class 720 is “1”. Therefore, it can be confirmed that the user JOB class 710 and the copy JOB class 720 have 1-to-1 correspondence relationship.

Referring back to FIG. 1, the schedule management section 113 manages the schedule of the user JOBs stored in the user JOB queue 112. As an example of managing the schedule, the order of the user JOBs in the user JOB queue 112 is changed based on the priority level 710d of each user JOB class 710.

As described above, the application control layer 102 manages a user's request unit (user JOB), and each application manages the corresponding application JOB that executes the actual process.

Further, the application control layer 102 collectively manages the user JOBs using the user JOB queue. Therefore, it becomes possible to change the priority of execution of applications and execute a prescribed process first.

The application shared service layer 104 includes a rights management table 131 and a rights determination section 132, and collectively controls the resources that of the MFP 100 and that are used by each application. Further, the application shared service layer 104 stores a control data element corresponding to a using request from each application.

Namely, as described above, each application is arranged to have the processing logic and the user interface only. As a result, the application shared service layer 104 is arranged to have the other functions (for example, a security function) that would be included in each application in a conventional apparatus.

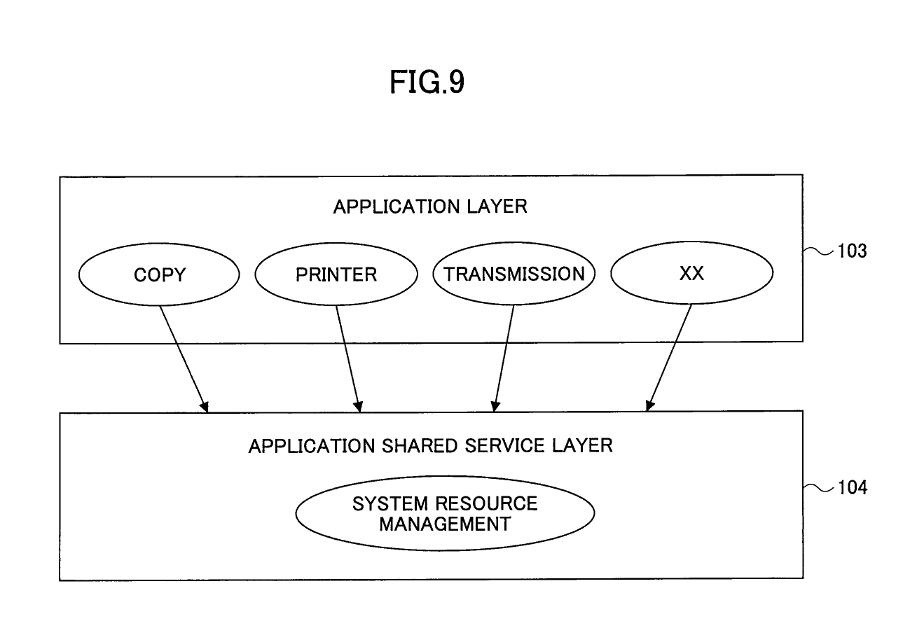

FIG. 9 shows a relationship between the application layer 103 and the application shared service layer 104. As shown in FIG. 9, each application in the application layer 103 is capable of using a service provided by system resource management of the application shared service layer 104.

As an example of the service provided for each application by the application shared service layer 104, there is access control to a hardware resource. Next, the access control service provided by the application shared service layer 104 is described.

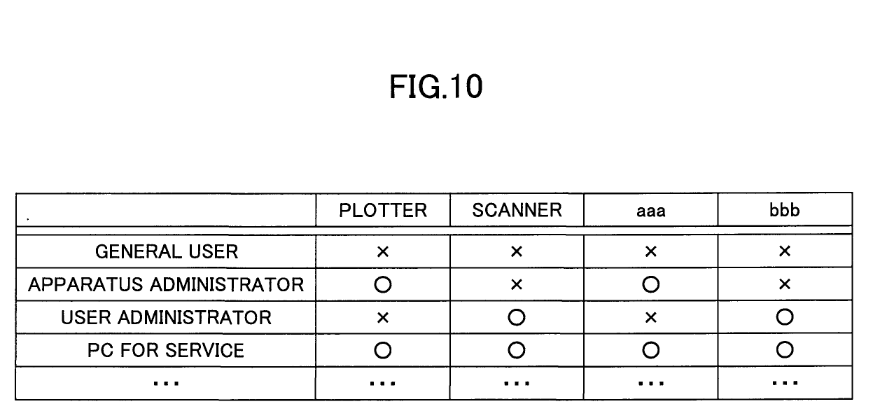

The rights management table 131 stores the information necessary for a user's access control. FIG. 10 shows a table configuration of the rights management table 131. As shown in FIG. 10, the rights management table 131 stores the information of the access rights of each user with respect to each hardware resource of the MFP 100.

When a using request for the hardware resource is received from an application, the rights determination section 132 determines whether there is a right to access to the requested hardware resource based on user information received along with the using request.

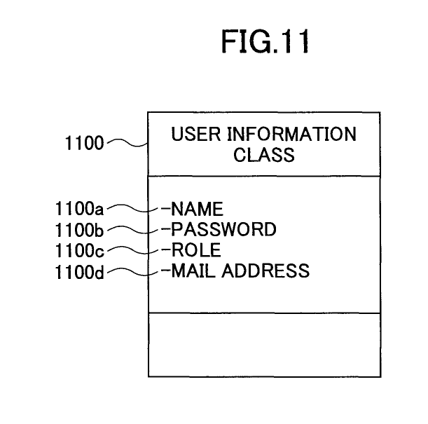

FIG. 11 shows a class configuration of the user information received from the application. As shown in FIG. 11, the user information class 1100 includes the attributes of a “Name” 1100a, a “Password” 1110b, and a “Role” 1100c, and a “Mail address” 1100d.

The “Name” 1100a stores the user ID of the user who issues the using request. The “Password” 1100b stores the password corresponding to the user ID. The “Role” 1100c stores the role (class) of the user. The “Mail address” stores the mail address of the user.

The rights determination section 132 determines whether the user can access the hardware resource based on the role of the user included in the user information and the rights management table 131. As described above, when an application is required to use a hardware resource, only the rights determination section 132 in the application shared service layer 104 needs to be checked. Therefore, the serviceability of the MFP 100 can be improved.

Further, in addition to the access control, the application shared service layer 104 provides various services that can be commonly used among applications to each application. By using the service, each application in the application layer 103 can use a system resource through the application shared service layer 104.

When the power of the MFP 100 is turned ON and initiates the OS 106, a sharing mechanism 105 is executed first and loads layers that are described below, the user interface layer 101, including the application control layer 102, the application layer 103, and the application shared service layer 104. For example, the sharing mechanism 105 loads a group of the software programs from a flash memory (not shown) into a memory area of a SRAM or SDRAM (not shown) and initiates the group of software programs.

Further, the sharing mechanism 105 provides an exception management service to and monitors the user interface layer 101, the application control layer 102, the application layer 103, and the application shared service layer 104.

The OS 106 is an operating system such as UNIX (Registered trademark), and executes in parallel the software included in the application layer 103, the sharing mechanism 105, the user interface layer 101, the application control layer 102, and the application shared service layer 103 as processes.

In the MFP 100 according to the above embodiment of the present invention, the part of controlling an application is performed in the application control layer 102, and the parts of common services for each application are performed in the application shared service layer 104. Namely, internal processes (the above processing logic unique to each application) and external processes are separated from each other.

Since the MFP 100 according to an embodiment of the present invention has the above configuration, the number of parts where an application is implemented can be reduced. Further, it is possible for the framework of the MFP 100 to not be substantially influenced even when an application is added or deleted. The term “framework” refers to the software for executing the external processes of the application, the software including the application control layer 102, application shared service layer 103, and the sharing mechanism 105.

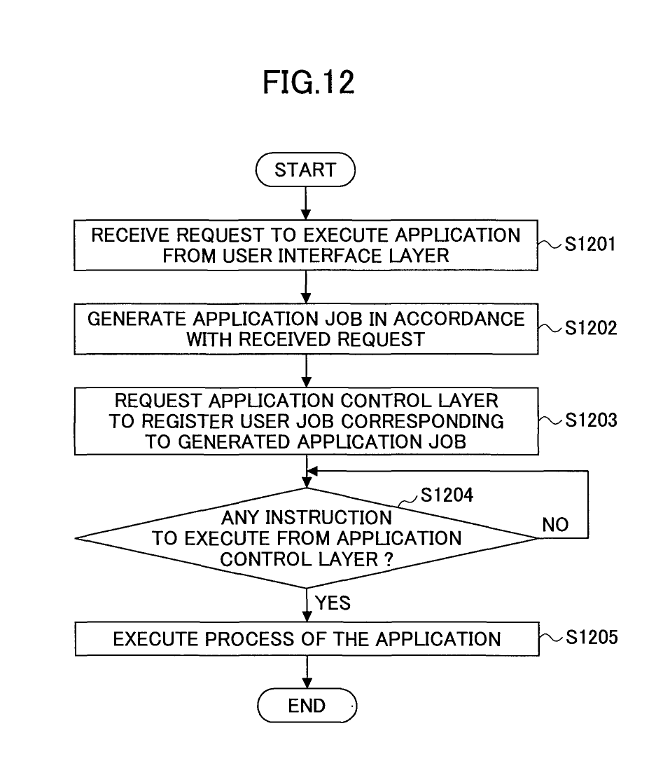

Next, the processes from when an application in the thus-configured application layer 103 according to an embodiment of the present invention receives a request for executing the application to when the application executes the process are described. FIG. 12 is a flowchart showing the above processes for an application in the application layer 103 according to an embodiment of the present invention.

Any application in the application layer 103 receives a request for executing the application from the user interface layer 101 (step S1201).

Next, the application generates an application JOB corresponding to the received request (step S1202). The application JOB is generated by embodying the application JOB class 720 shown in FIG. 7. Then, the application stores the generated application JOB.

Next, the application requests the application control layer 102 to register the user JOB corresponding to the generated application JOB (step S1203). Further, the application transmits the user information received from the user interface layer 101 to the application control layer 102. By doing this, the application control layer 102 generates the user JOB, and the generated user JOB and the application JOB generated in step S1202 are associated with each other.

Next, the application determines whether an instruction for executing the application JOB is received from the application control layer 102 (step S1204). When it is determined that the instruction is not received (NO in step S1204), the application waits until the instruction for execution is received.

When the applications determines that the instruction for the execution is received from the application control layer 102 at the application JOB (YES in step S1204), the application executes the process based on the application JOB (S1205).

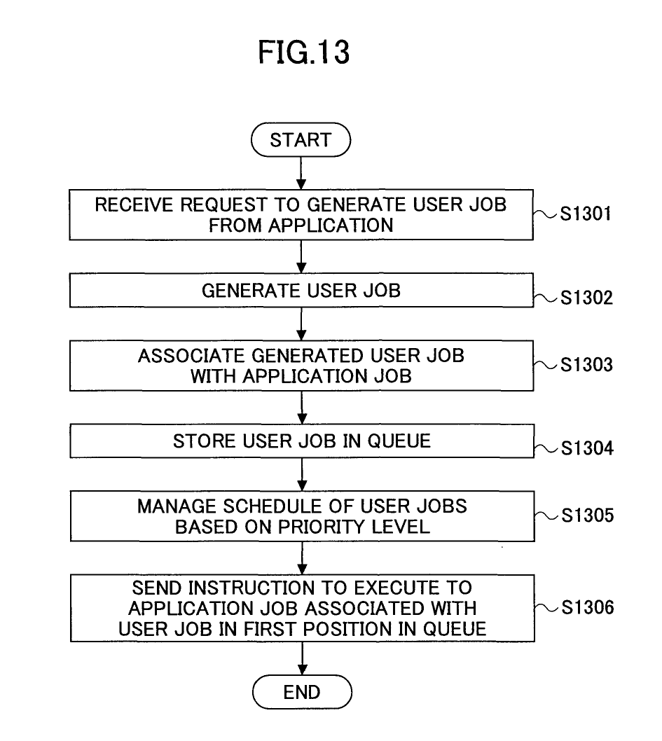

Next, the processes from when the thus-configured application control layer 102 according to an embodiment of the present invention receives the request for registering the user JOB from the application, to when an instruction for execution is transmitted to the application are described. FIG. 13 is a flowchart showing the above processes in the application control layer 102.

First, the application control layer 102 receives a request for registering the user JOB from the application (step S1301).

Next, the application control layer 102 generates the user JOB based on the registration request (step S1302). The user information input from the application is stored in each corresponding attribute of the generated user JOB.

Then, the application control layer 102 associates the generated user JOB and the application JOB stored by the application that transmits the registration request (step S1303).

Next, the application control layer 102 stores the user JOB in the user JOB queue 112 (step S1304).

Then, the schedule management section 113 in the application control layer 102 manages the schedules of the user JOBs based on the priority level of the user JOBs in the user JOB queue 112 (step S1305).

Next, the application control layer 102 issues an instruction for executing the process to the application JOB associated with the user JOB in the first position of the user JOB queue 112 (step S1306).

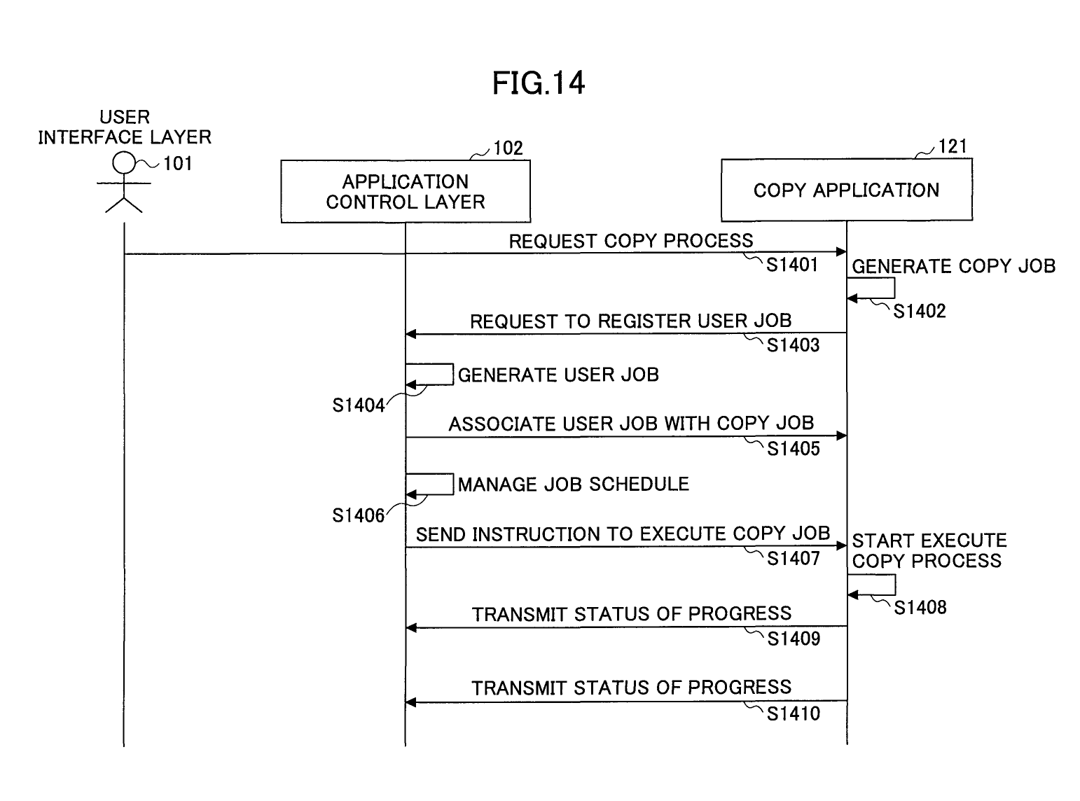

Next the execution processes from receiving a copy request to the execution of a copy process are described in conjunction with an example. FIG. 14 is a sequence diagram showing the procedure after the copy application 121 receives a copy request from the user interface layer 101.

First, the user interface layer 101 transmits a request for a copy process to the copy application 121 (step S1401).

Next, the copy application 121 generates the copy JOB in accordance with the input request for the copy process (step S1402).

Then, the copy application 121 transmits a request for registering the user JOB to the application control layer 102 (step S1403).

To respond to the request, the application control layer 102 generates the user JOB (step S1404). Next, the application control layer 102 associates the generated user JOB with the copy JOB in the copy application 121 (step S1405). Also, the application control layer 102 places the associated user JOB in the user JOB queue 112.

Then, the schedule management section 113 in the application control layer 102 manages the schedules based on the priority levels of the user JOBs in the user JOB queue 112 (step S1406).

Next, the application control layer 102 instructs the copy JOB associated with the user JOB stored in the user JOB queue 112 to execute a copy process (step S1407). It should be noted that, in the processes, the user JOB associated with the copy JOB is in the first position in the user JOB queue 112.

To respond to the instruction to execute the copy process, the copy application 121 starts the execution of the copy process (step S1408).

After the copy process is started, the copy job periodically transmits the status of the process being executed to the application control layer 102 (steps S1409 and S1410). By doing this, the application control layer 102 can recognize the status of the executing process and the finish of the process. Then, when an other user JOB is placed in the user JOB queue 112, the application control layer 102 issues an instruction to execute the application JOB associated with the other user JOB.

In the MFP 100 according to the embodiment of the present invention, a process received from a user can be executed by the processes as described above.

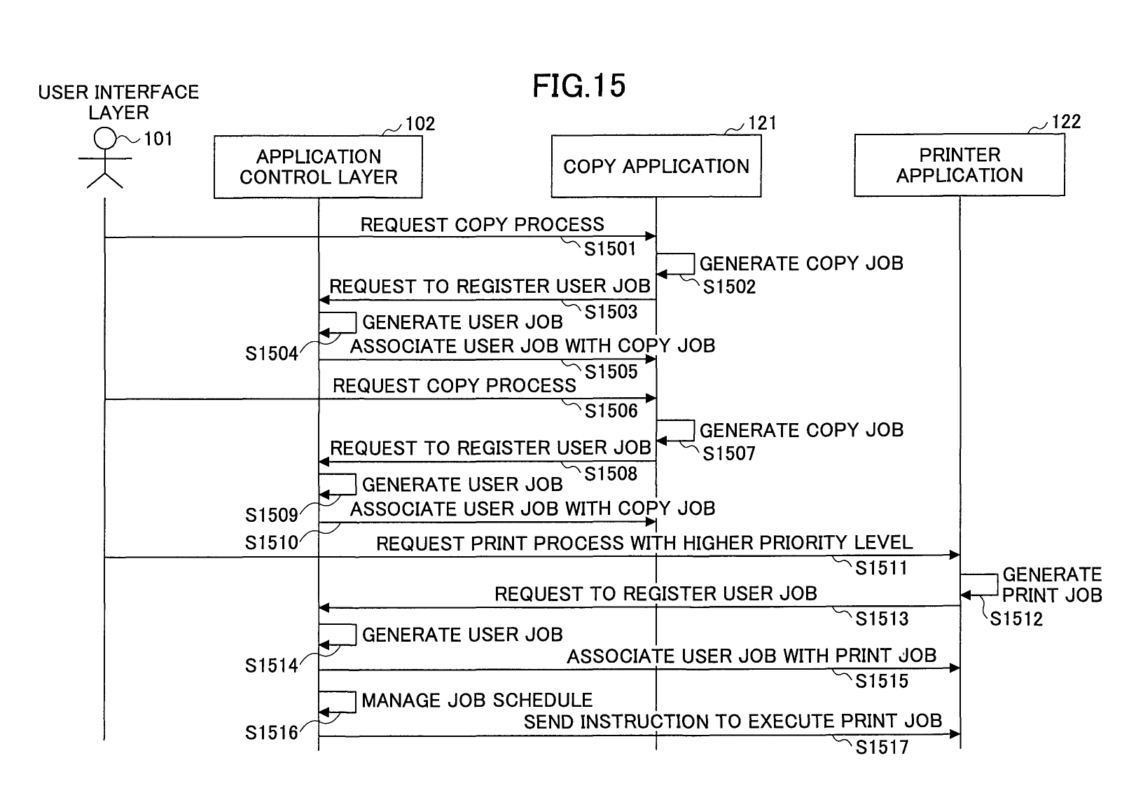

Next, the execution processes from when a copy request and a print request having higher priority are received to when the print process is executed are described in conjunction with an example are described. FIG. 15 is a sequence diagram showing the processes when a copy request and a print request are received from the user interface layer 101.

First, the user interface layer 101 issues a request for a first copy process to the copy application 121 (step S1501).

Next, the copy application 121 generates the copy JOB in accordance with the request for the first copy process (step S1502).

Then, the copy application 121 requests the application control layer 102 to register the user JOB (step S1503).

To respond to the request, the application control layer 102 generates the user JOB (step S1504). Next, the application control layer 102 associates the generated user JOB with the copy JOB (storing the information of the first copy process) (step S1505). Then, the application control layer 102 places the associated user JOB in the user JOB queue 112.

Further, the user interface layer 101 issues a request for a second copy process to the copy application 121 (step S1506).

Next, the copy application 121 generates the copy JOB in accordance with the request for the second copy process (step S1507).

Then, the copy application 121 requests the application control layer 102 to register the user JOB (step S1508).

To respond to the request, the application control layer 102 generates the user JOB (step S1509). Next, the application control layer 102 associates the generated user JOB with the copy JOB (storing the information of the second copy process) (step S1510). Then, the application control layer 102 places the associated user JOB in the user JOB queue 112.

Next, the user interface layer 101 issues a request for a print process having a higher priority level to the printer application 122 (step S1511).

Then, the printer application 122 generates the print JOB in accordance with the request for the print process (step S1512).

Then, the printer application 122 requests the application control layer 102 to register the user JOB (step S1513).

To respond the request, the application control layer 102 generates the user JOB (step S1514). It should be noted that a higher value is set to the priority level that is one of the attributes in this user JOB.

Then, the application control layer 102 associates the generated user JOB with the print JOB in the printer application 122 (step S1515). Further, the application control layer 102 places the associated user JOB in the user JOB queue 112.

Next, the schedule management section 113 in the application control layer 102 manages the schedules based on the priority level in each user JOB in the user JOB queue 112 (step S1516).

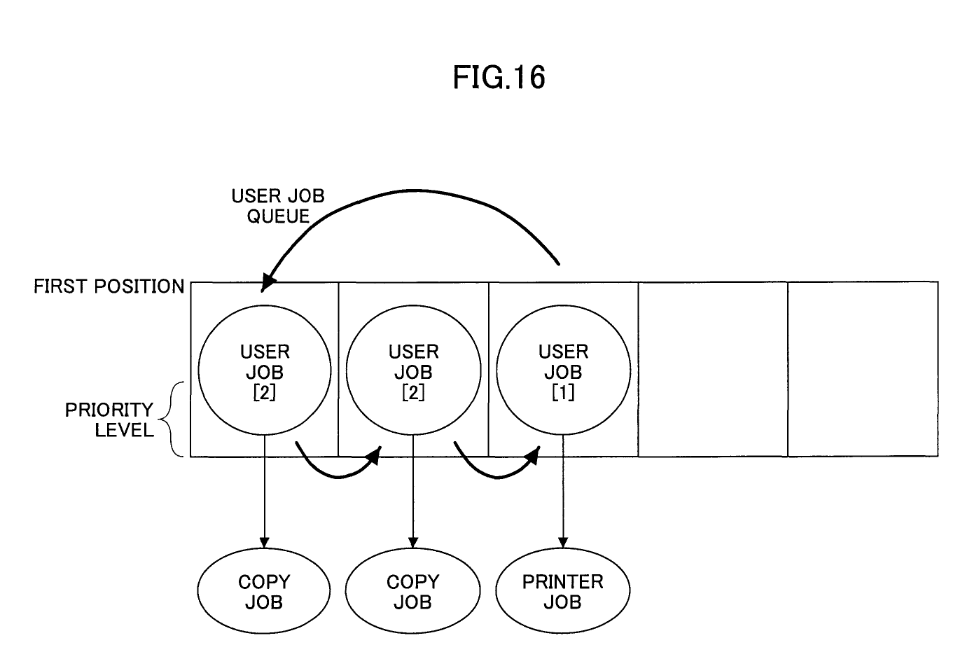

FIG. 16 is a drawing schematically showing the schedule management performed by the schedule management section 113 based on the priority level. As shown in FIG. 16, the schedule management section 113 refers to the priority level of each user JOB to sort the user JOBs in decreasing order with respect to the priority level. In this example, since the user JOB associated with the printer JOB has a higher priority level, this user JOB is arranged in the first position of the user JOB queue 112.

Referring back to FIG. 15, the application control layer 102 issues an instruction for executing the print process to the printer JOB associated with the user JOB in the first position of the user JOB queue 112 (step S1517).

By this manner, the print process of the printer application 122 can be executed first. As described above, in the MFP according to an embodiment of the present invention, an order of executing processes can be changed even when plural application JOBs are included in the order.

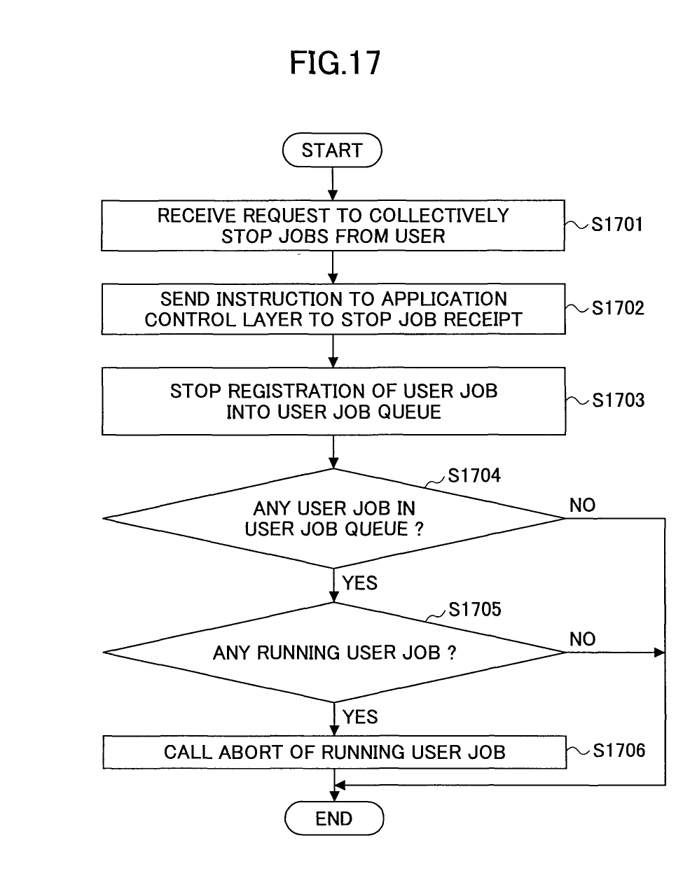

Next, processes to collectively stop the JOB executed in the thus configured MFP according to an embodiment of the present invention are described. FIG. 17 is a flowchart showing the above processes in the MFP according to an embodiment of the present invention.

First, the user interface layer 101 receives a request for stopping JOBs collectively from a user (step S1701).

Next, the user interface layer 101 issues an instruction to collectively stop receiving a job to the application control layer 102 (step S1702).

Then, the application control layer 102 stops the registration of the user JOB in the user JOB queue 112 (step S1703). By doing this, since there is no additional registration of the user JOB from the application, no further request for a new process can be received.

Next, the application control layer 102 determines whether any user JOB is in the user JOB queue 112 (step S1704). When it is determined that there is no user JOB (NO in step S1704), the process ends without performing any specific process.

On the other hand, when the application control layer 102 determines that there is a user JOB (YES in step 1704), the application control layer 102 determines whether there is any running user JOB (step S1705). When it is determined that no user JOB is running (NO in step S1705), the process ends without performing any specific process.

When the application control layer 102 determines that there is a running user JOB (YES in step 1705), the application control layer 102 calls the operation “abort( )” for the running user JOB (step S1706). By doing this, an abortion is issued to the application JOB associated with the user JOB whose operation “abort( )” is thus called.

By the procedure described above, the processes being executed in the MFP 100 can be collectively stopped.

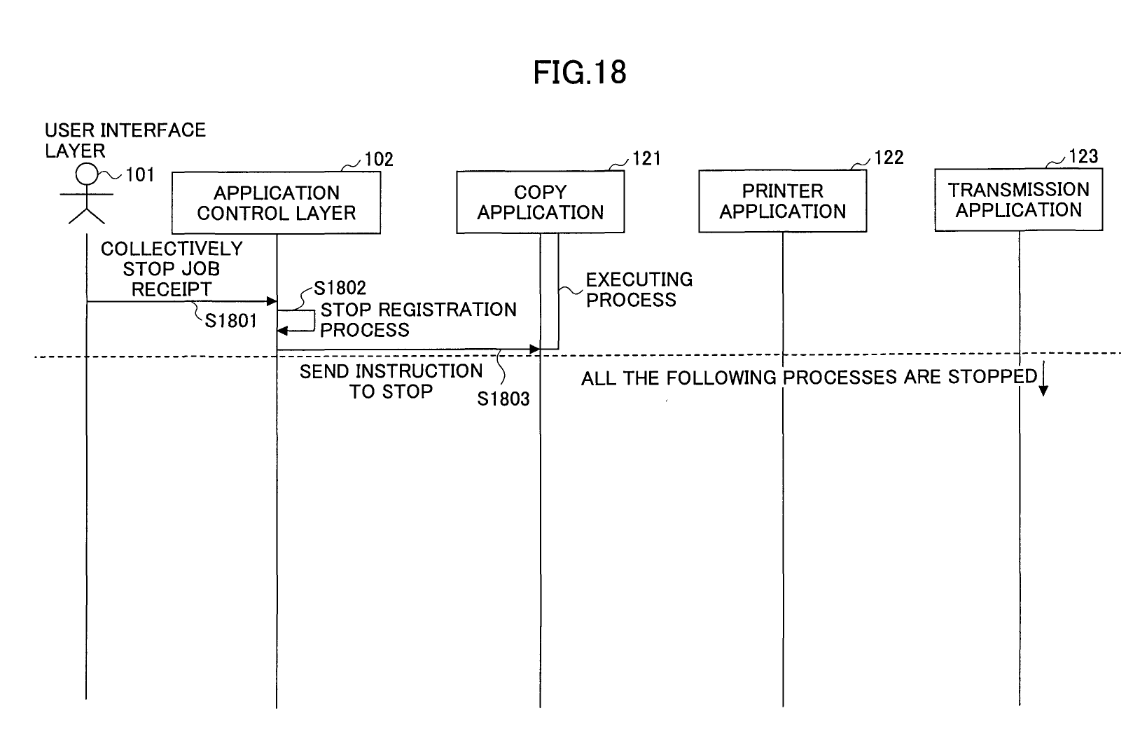

Next, data transmission when jobs are collectively stopped is described in conjunction with an example. FIG. 18 is a sequence diagram showing execution processes when an instruction to collectively stop jobs is issued from the user interface layer 101.

In the processes, it is assumed that a copy JOB of the copy application is being executed.

First, the user interface layer 101 transmits a request to collectively stop the execution of JOBs to the application control layer 102 (step S1801).

Next, the application control layer 102 stops a registration process for the user JOB queue 112 (stop S1802). Then, the application control layer 102 identifies a running user JOB according to the steps S1704 and S1705 in FIG. 17. In this process, the application control layer 102 identifies the user JOB associated with the copy JOB as a running JOB.

Then, the application control layer 102 transmits an instruction to the running user JOB to stop the execution of the JOB. Accordingly, the user JOB transmits an instruction to the associated copy JOB to stop the execution of the JOB (step S1803).

By doing this, in the MFP 100, the processes of the applications (the printer application 122 and the transmission application 123) in addition to the running copy application 121 are also stopped.

In other words, in a conventional MFP, since each application possesses its job, it is necessary to transmit an instruction to each application separately. On the other hand, in the MFP 100 according to an embodiment of the present invention, since the user JOB queue collectively manages the JOBs, it is possible to stop receiving a new JOB only by stopping the registration in the user JOB queue 112. Because of this configuration, the processes of all the application can be stopped only by stopping a currently running application.

In addition, in a case where a new application is added in the application layer 103, in a conventional MFP, it is necessary to modify software so that an instruction is transmitted to the added application to stop its JOB. However, in the MFP 100, even when a new application is added, it is not necessary to modify the application control layer 102 to realize the function to stop receiving JOBs. Further, in the added application, implementation to reject receiving a JOB is not necessary. Because of this feature, in the MFP 100, it is possible to reduce the labor-hours when a new application is added.

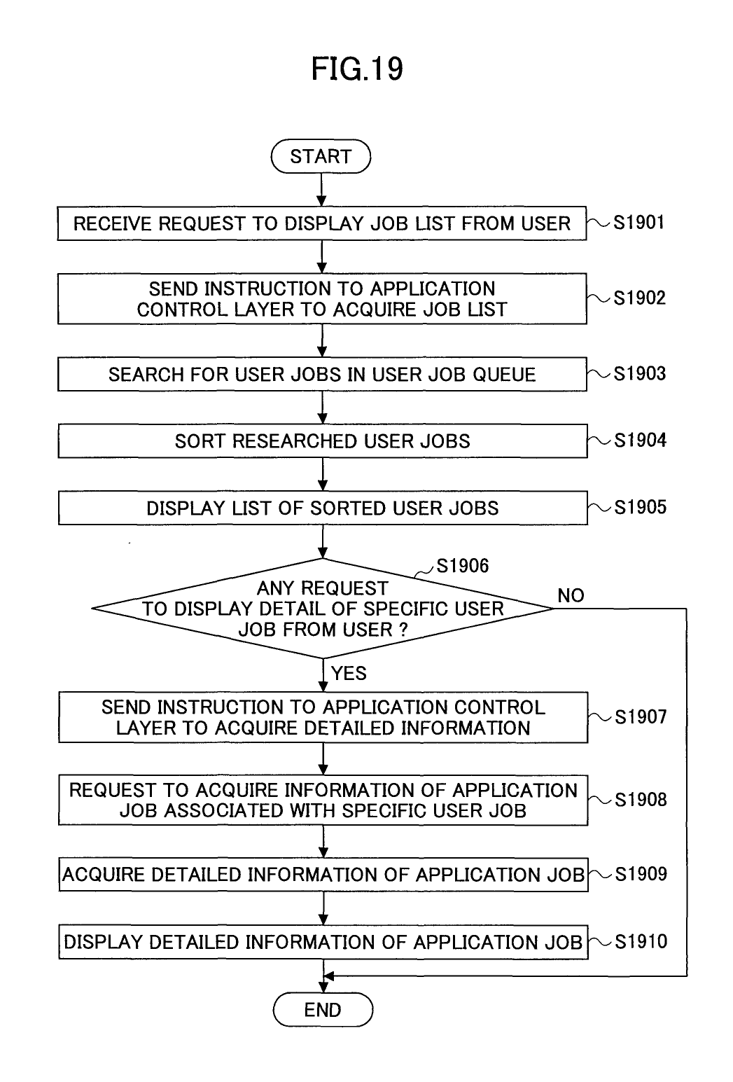

Next, the processes to display a list of JOBs in the thus-configured MFP 100 are described. FIG. 19 is a flowchart showing the above processes in an MFP 100 according to an embodiment of the present invention.

First, the user interface layer 101 receives a request to display a list of JOBs from a user (step S1901).

Next, the user interface layer 101 transmits an instruction to obtain a list of JOBs to the application control layer 102 (step S1902).

After receiving the instruction, the application control layer 102 searches for the user JOBs in the user JOB queue 112 (step S1903).

Then, the application control layer 102 sorts the searched for and located user JOBs into a format easy to display (step S1904). Then, the sorted user JOBs are transmitted to the user interface layer 101.

By doing this, the application control layer 102 displays a list of the sorted user JOBs (step S1905).

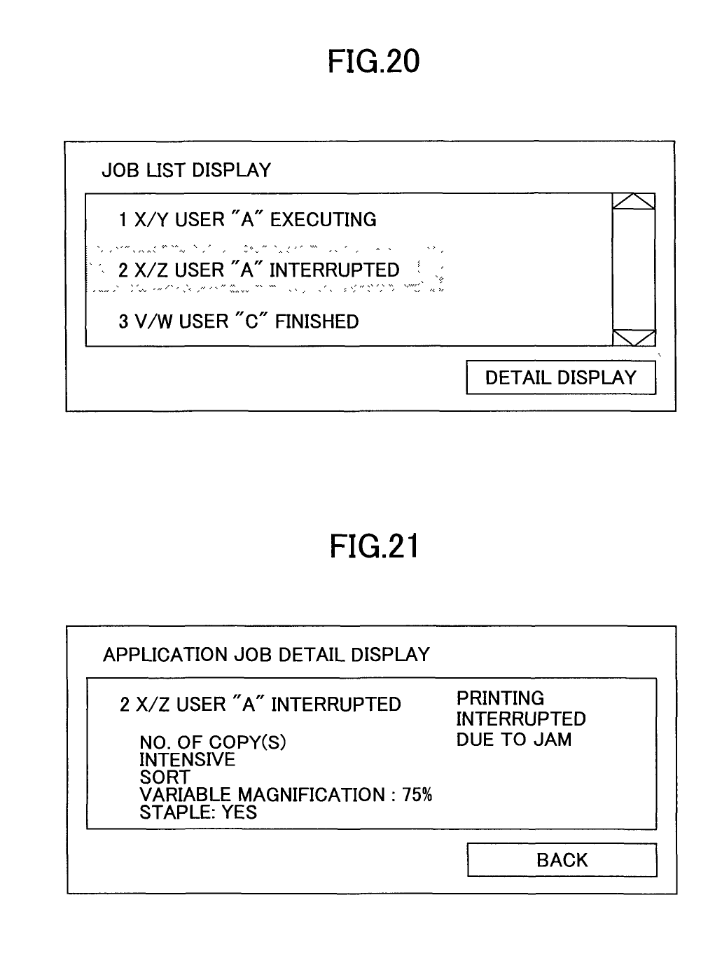

FIG. 20 shows an exemplary list of the user JOBs displayed by the user interface layer 101. As shown in FIG. 20, the display includes the “Name of creator” and the “JOB status” (“Executing”, “Interrupted”, or “Finished”) as attributes of the user JOBs.

Referring back to FIG. 19, the user interface layer 101 determines whether a request to display the details of a specific usr JOB from among the user JOBS on the list is received (step S1906). When it is determined that the request to display the details of a specific user JOB is not received (NO in step S1906), the process goes to end.

When the user interface layer 101 determines that the request to display the details of a specific usr JOB is received (YES in step S1906), the user interface layer 101 transmits an instruction to acquire detailed information of the specific user JOB to the application control layer 102 (step S1907).

To respond to the instruction, the application control layer 102 transmits a request to acquire detailed information to the application JOB associated with the specific user JOB (step S1908).

By doing this, the application control layer 102 acquires the detailed information (information stored as the attribute “Operating conditions”) of the application JOB from the application JOB (step S1909). Then, the application control layer 102 transmits the acquired detailed information of the application JOB to the user interface layer 101.

Then, the user interface layer 101 displays the transmitted detailed information of the application JOB (step S1910).

FIG. 21 is exemplary detailed information of a user JOB displayed by the user interface layer 101. As shown in the exemplary display of FIG. 21, the information of the “Operating conditions” as the attribute of the application JOB is displayed.

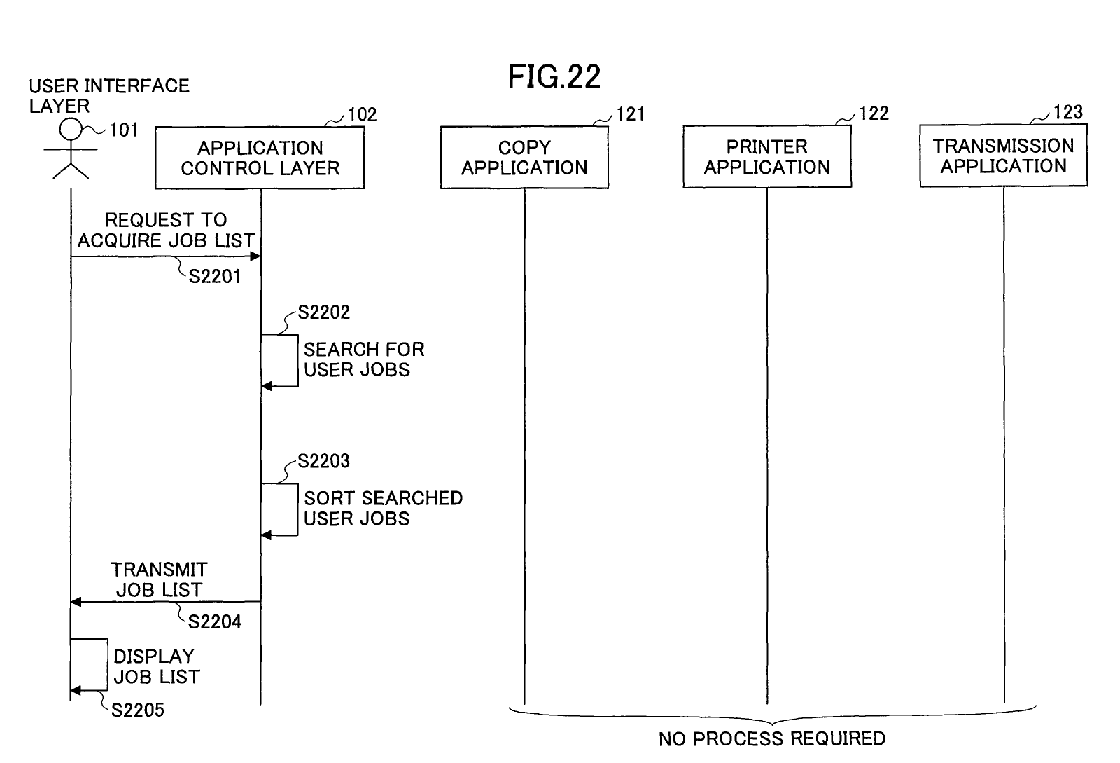

Next, the data transmission when JOB list is displayed in the MFP 100 is described in conjunction with an example. FIG. 22 is a sequence diagram showing the processes when the user interface layer 101 receives the request to display a JOB list.

First, the user interface layer 101 transmits a request to acquire a JOB list to the application control layer (step S2201).

Next, the application control layer 102 searches for user JOBs in the user JOB queue 112 (step S2202).

Then, the application control layer 102 sorts the searched for and located user JOBs (step S2203).

Next, the application control layer 102 transmits the sorted user JOBs to the user interface layer 101 (step S2204).

Then, the user interface layer 101 displays the sorted user JOBs (step S2205).

The MFP 100 can call for the JOB list according to the processes shown in FIGS. 19 through 22, and can display the detailed information of the JOBs. In the MFP, the JOB list can be displayed without checking the JOBs processed by each application.

Namely, in an MFP according to an embodiment of the present invention, when a new application is added, it is not necessary to modify the application control layer to display a JOB list including the JOBs of the new application. In addition, additional implement to the application is not necessary to display a JOB list.

In an MFP 100 according to an embodiment of the present invention, when an application needs to use a hardware resource during the execution of the application JOB, the application needs to access the application shared service layer 104. Then, the accessed application shared service layer 104 determines whether there is a right to use the hardware resource.

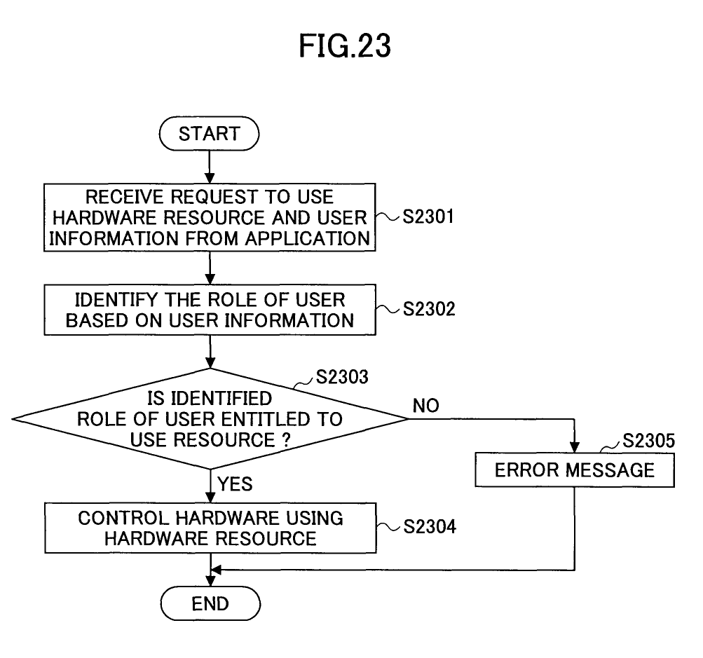

Next, the processes by which the application shared service layer 104 determines whether there is a right to use a hardware resource when an application needs to use the hardware resource are described below. FIG. 23 is a flowchart showing the above processes in the MFP 100 according to an embodiment of the present invention.

First, the application shared service layer 104 receives a request to use a hardware resource along with the user information from an application (step S2301). Herein, it is assumed that the user information can be identified from the “Name of creator”, an attribute of the application JOB. Further, it is assumed that the user information is stored in a storage section (not shown) in the MFP 100 in advance, and the user information includes the attributes shown in FIG. 11.

Then, the application shared service layer 104 identifies the role of the user from the user information (step S2302).

Next, the rights determination section 132 determines whether the identified role of the user includes the right to use the hardware resource based on the rights management table 131 (step S2303).

When the rights determination section 132 determines that there is a right (YES in step 2303), the application shared service layer 104 controls the hardware by using the hardware resource based on the request to use the hardware from the application (step S2304).

When the rights determination section 132 determines that there is not a right (NO in step 2303), the application shared service layer 104 transmits an error message to the application (step S2305).

According to the above processes, the MFP 100 can determine whether there is a right to use a hardware resource whenever an application needs to use the hardware resource.

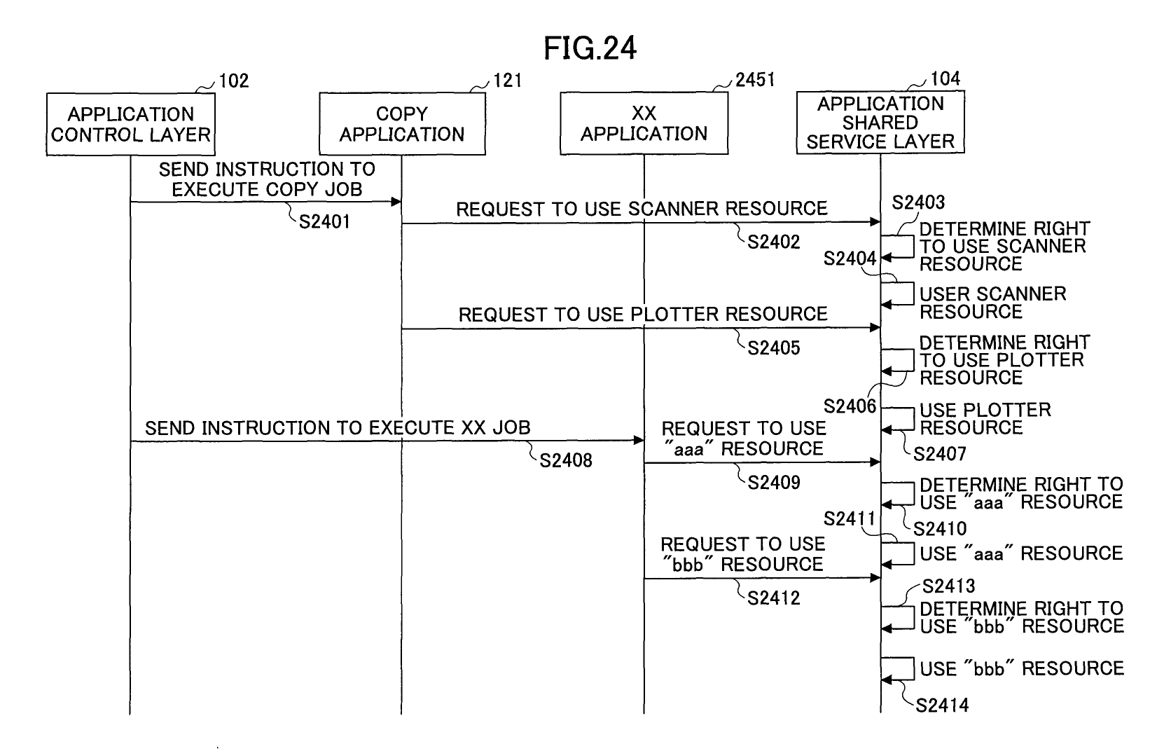

Next, the processes from when an instruction to execute an application is transmitted to when each hardware resource is used are described in conjunction with an example. FIG. 24 is a sequence diagram for when the application control layer 102 issues an instruction to execute a JOB. Herein, a “XX application” 2451 is an application that is newly added to the MFP 100.

The application control layer 102 transmits an instruction to execute the copy JOB based on the user JOBs arranged in the user JOB queue 112 (step S2401).

To respond to the instruction, the copy application 121 starts execution of the copy JOB. Then, according to the copy JOB, the copy application transmits a request to use a scanner resource to use the scanner resource to the application shared service layer 104 (step S2402). In this case, the copy application transmits the user information as well.

Then, the rights determination section 132 in the application shared service layer 104 determines whether the role of the user in the user information is entitled to use the scanner resource (step S2403). In the processes, it is assumed that the role of the user is entitled to use the scanner resource.

Then, the application shared service layer 104 controls the scanner by using the scanner resource (step S2404).

Next, according to the copy JOB, the copy application 121 transmits a request to use a plotter resource to use a plotter to the application shared service layer 104 (step S2405). In this case as well, the copy application transmits the user information.

Then, the rights determination section 132 in the application shared service layer 104 determines whether the role of the user in the user information is entitled to use the plotter resource (step S2406). In the processes, it is assumed that the role of the user is entitled to use the plotter resource.

Then, the application shared service layer 104 controls the plotter by using the plotter resource (step S2407).

The application control layer 102 transmits an instruction to execute the XX JOB to the XX application according to the order of the user JOBs in the user JOB queue 112 (step S2408).

Accordingly, the XX application 2451 starts the execution of the XX JOB. According to the XX JOB, the XX application 2451 transmits a request to use an “aaa” resource to use “aaa” hardware (hardware of the MFP 100) to the application shared service layer 104 (step S2409). In this case, the XX application 2451 transmits the user information as well.

Then, the rights determination section 132 in the application shared service layer 104 determines whether the role of the user in the user information is entitled to use the “aaa” resource (step S2410). In the processes, it is assumed that the role of the user is entitled to use the “aaa” resource.

Then, the application shared service layer 104 controls the “aaa” hardware by using the “aaa” resource (step S2411).

Next, according to the XX JOB, the XX application 2451 transmits a request to use “bbb” resource to use “bbb” hardware (hardware of the MFP 100) to the application shared service layer 104 (step S2412). In this case, the XX application 2451 transmits the user information as well.

Then, the rights determination section 132 in the application shared service layer 104 determines whether the role of the user in the user information is entitled to use the “bbb” resource (step S2413). In the processes, it is assumed that the role of the user is entitled to use the “bbb” resource.

Then, the application shared service layer 104 controls the “bbb” hardware by using the “bbb” resource (step S2414).

As described in the above processes, the application shared service layer 104 includes resources that each application uses. Because of this structure, the application shared service layer 104 can recognize whether the resources are being used. As a result, each application doesn't have to include the resources, thereby reducing the labor-hours in developing the applications.

Further, security may be improved because the application shared service layer 104 alone controls the accesses to the hardware resources.

The above MFP 100 is different from a conventional MFP in that a controlling part of the applications is implemented in the application control layer 102, and a part of providing a common service to each application is separately implemented in the application shared service layer 104. This is because, in a conventional MFP, the part of providing a common service to each application is included in each application.

Further, in the MFP 100, as shown in FIG. 2, only the processing logic 202 and the user interface 201 are included in each application. In this manner, processes in the MFP 100 are divided into the internal processes and the external processes (“framework”). By doing this, dependency between the framework and the applications is reduced, thereby facilitating the addition and deletion of applications to and from the MFP 100, respectively.

Still further, in the MFP 100, since the external processes are extracted from each application, the parts to be implemented in each application can be reduced, thereby reducing labor-hours for developing the applications. Still further, in the MFP 100, since the addition and deletion of an application does not influence the “framework”, it is possible to reduce the labor-hours for the development.

Still further, in the MFP 100, the role of each component of the software group is specified more clearly, and the control part that is included in each application in a conventional MFP is extracted from the application and implemented in external parts (application control layer 102 and the application shared service layer 104). As a result, the redundancy of the applications can be controlled, and the security of an MFP can be improved.

Still further, in the MFP 100, the application shared service layer 104 having a role of providing services to each application is extracted from the application. As a result, the parts to be implemented in each application can be reduced. Also, when a new function (for example, to improve the security) is required to be added to each application, what is necessary is to modify the application shared service layer 104 without modifying the applications. Because of this configuration, it is possible to localize the areas subject to influence by modifying the software of the MFP 100. Therefore, the labor-hours for the development can be reduced.

It should be noted that the advantages of the embodiments of the present invention are obvious in an apparatus having plural applications like the above MFP 100, but the advantages of the embodiments of the present invention are effective particularly in an apparatus having the above problem.

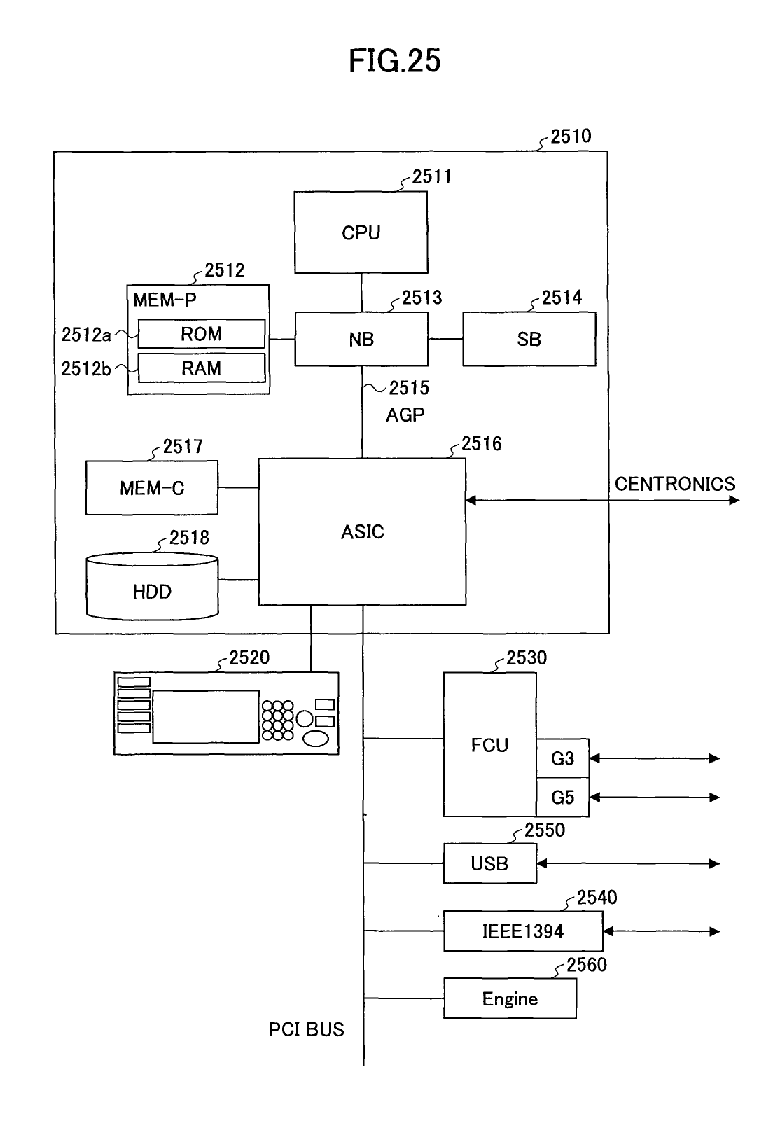

FIG. 25 is a block diagram showing an exemplary hardware configuration of the MFP 100. As shown in FIG. 25, the MFP 100 includes a controller 2510 and an engine 2560 connected to the controller 2510 via a Peripheral Component Interconnect (PCI) bus. The controller 2510 controls the entire MFP 100, creates an image, provides communications, and controls the input from an operations section 2520. The engine 2560 is, for example, a printer engine that can be connected via the PCI bus, and may be, for example, a black and white plotter, a 1-drum color plotter, a 4-drum color plotter, a scanner, and a facsimile machine. It should be noted that the engine 2560 includes an image processing section for, for example, error diffusion and gamma conversion in addition to the so-called engine of, for example, a plotter.

The controller 2510 includes a CPU 2511, a North Bridge (NB) 2513, a system memory (MEM-P) 2512, a South Bridge (SB) 2514, a local memory (MEM-C) 2517, an Application Specific Integrated Circuit (ASIC) 2516, and a Hard Disk Drive (HDD) 2518. The North Bridge (NB) and the ASCI 2516 are connected via an Accelerated Graphic Port (AGP) bus 2515. Further, the MEM-P 2512 includes a Read Only Memory (ROM) 2512a and a Random Access Memory (RAM) 2512b.

The CPU 2511 controls the entire MFP 100, and has a chipset including the NB 2513, the MEM-P 2512, and the SB 2514. The CPU 2511 is connected to external devices via the chipset.

The NB 2513 is a bridge for connecting between the CPU 2511 and the MEM-P 2512, SB 2514, and the AGP 2515, and includes a memeory controller for controlling, for example, reading and writing with respect to the MEM-P2512, a PCI master, and an AGP target.

The MEM-P2512 is a system memory used, for example, for storing programs and data, loading programs and data, drawing an image for a printer, and includes the ROM 2512a and the RAM 2512b. The ROM 2512a is a read only memory storing programs and data. The RAM 2512b is a random access memory for storing an image for a printer.

The SB 2514 is a bridge for connecting the NB 2513 and a PCI device to a peripheral device. The SB 2514 is connected to the NB 2513 via a PCI bus, and, for example, a network interface (I/F) is connected to the PCI bus.

The ASIC 2516 is an Integrated Circuit (IC) for image processing. The ASIC 2516 serves as a bridge for connecting the AGP 2515, the PCI bus, the HDD 2518, and the MEM-C 2517. The ASIC 2516 includes a PCI target, an AGP master, an arbiter (ARB) which is a center part of the ASIC 2516, a memory controller for controlling the MEM-C 2517, plural Direct Memory Access Controllers (DMAC) for, for example, rotating image data using a hardware logic, and a PCI unit for data transmission with the engine 2560 via the PCI bus. The ASIC 2516 is connected, via the PCI bus, to a Fax Control Unit (FCU) 2530, a Universal Serial Bus (USB) 2540, and the Institute of Electrical and Electronics Engineer 1394 (IEEE 1394) interface 2550.

The MEM-C 2517 is a local memory used as an image buffer for copying and a code buffer. The HDD 2518 is a storage for storing image data, programs, font data, and forms.

The AGP 2515 is a bus interface for a graphic accelerator card for accelerating graphics operations, and accelerates the processing in the graphic accelerator card by directly accessing the MEM-P 2512 with high throughput.

It should be noted that the information processing programs executed in the MFP 100 according to an embodiment of the present invention are provided in, for example, the ROM.

Further, the information processing programs executed in the MFP 100 according to an embodiment of the present invention may be recorded in a computer-readable medium such as a CD-ROM, a Flexible Disk (FD), a CD-R, and a Digital Versatile Disk (DVD) as a file having an installable or an executable format.

Still further, the information processing programs executed in the MFP 100 according to an embodiment of the present invention may be stored in a computer connected to a network such as the Internet so that the programs are provided via the network download. Still further, the information processing programs executed in the MFP 100 according to an embodiment of the present invention may be provided or distributed via a network such as the Internet.

Still further, the information processing programs executed in the MFP 100 according to an embodiment of the present invention are divided into modules including the above parts (OS, the sharing mechanism, the user interface layer, the application control layer, the application layer, the application shared service layer). After the information processing programs are loaded from the ROM by the CPU (processor) and then executed, the above each parts are held in a main memory and the OS, the sharing mechanism, the user interface layer, the application control layer, the application layer, and the application shared service layer are generated in the main memory.

As described above, an information processing apparatus and an information processing program according to an embodiment of the present invention are useful when plural applications are being executed, especially, are advantageous when an application is added or deleted because of no necessity to modify other programs.

The present invention is not limited to the above embodiments, and variations and modifications may be made without departing from the scope of the present invention.

The present application is based on and claims the benefit of priority of Japanese Patent Application No. 2007-067972, filed on Mar. 16, 2007, the entire contents of which are hereby incorporated herein by reference.

What is claimed is:

1. An information processing apparatus comprising:
plural applications each executing an application process based on settings different from those of the other applications;
plural jobs each having settings common to the applications and representing a receipt of a request for the application process with respect to the corresponding application; and
an application control section collectively managing the plural jobs and issuing an instruction to execute the application process received by the job to the application capable of executing the application process received by the job based on managing the plural jobs.

2. The information processing apparatus according to claim 1, wherein
the application control section issues the instruction to execute the application process using a common command to each of the applications; and
each of the applications executes the application process in accordance with the common command.

3. The information processing apparatus according to claim 2, wherein
the application control section includes application managing information that stores application information for identifying each of the applications, and
the application control section issues an instruction using the common command to an application identified by the application information included in the application managing information.

4. The information processing apparatus according to claim 1, wherein
each of the applications includes an application job including operating conditions that are unique to the each of the applications and that are received settings for executing the application process, and
the application control section collectively manages the jobs associated with the corresponding application jobs of the corresponding applications.

5. The information processing apparatus according to claim 4, wherein
each of the applications generates the application job upon receiving a request for the application process, and issues a request to register the job to the application control section, and
the application control section generates the job upon receiving the request to register the job from the application, and associates the generated job with the application job of the application that issued the request for the registration.

6. The information processing apparatus according to claim 4, wherein
the application control section further includes a queue including the collectively managed jobs, and based on the order of jobs arranged in the queue, issues an instruction to the application capable of executing the application process received by each job to execute the application process received by the job.

7. The information processing apparatus according to claim 6, wherein
the application control section further includes a schedule managing section for changing the order of jobs arranged in the queue.

8. The information processing apparatus according to claim 1, further comprising:
a shared service section providing a resource to control hardware for the application.

9. The information processing apparatus according to claim 8, wherein
the application issues a request to use a resource along with user information of a user using the application to the shared service section,
the shared service section includes rights management information managing whether the user has a right to use a resource,
the shared service section further includes a rights determination section that upon receiving the request to use the resource from the application, determines whether the user identified by the user information has the right to use the resource using the rights management information, and
when it is determined that the user has the right to use the resource, the shared service section provides the resource for the application.

10. The information processing apparatus according to claim 1, wherein
the application includes processing information representing logic for executing the application process unique to each application, and an interface used when an apparatus other than the information processing apparatus is used upon the execution of the process by the processing information.

11. An information processing program for causing a computer to function as means for executing plural applications each executing an application process representing a process performed with settings unique to each application, the program comprising:
plural jobs each having settings common to the applications and representing a receipt of a request for the application process with respect for the corresponding application; and
application control means collectively managing the plural jobs and issuing an instruction to execute the application process received by the job to the application capable of executing the application process received by the job based on managing the plural jobs.

12. The information processing program according to claim 11, wherein
the application control means issues the instruction to execute the application process using a common command to each of the applications.

13. The information processing program according to claim 12, wherein
the application control means uses an application managing information storing application information for identifying each of the applications, and issues an instruction using the common command to an application identified by the application information stored in the application managing information.

14. The information processing program according to claim 11, wherein
the application control means collectively manages the jobs associated with the corresponding application jobs of the corresponding applications and that includes operating conditions unique to each of the applications.

15. The information processing program according to claim 14, wherein
the application control means generates the job upon receiving the request to register the job from the application, and associates the generated job with the application job of the application that issued the request for the registration.

16. The information processing program according to claim 14, wherein
the application control means further includes a queue including the collectively managed jobs, and based on the order of jobs arranged in the queue, issues an instruction to the application capable of executing the application process received by each job to execute the application process received by the job.

17. The information processing program according to claim 16, wherein
the application control means further includes a schedule managing section for changing the order of jobs arranged in the queue.

18. The information processing program according to claim 11, further comprising:
a shared service means providing a resource to control hardware for the application that received the instruction to execute the process from the application control means.

19. The information processing program according to claim 18, wherein
the shared service means further includes a rights determination means that upon receiving a request to use a resource along with user information for identifying a user from the application, determines whether the user identified by the user information has a right to use the resource using rights management information indicating whether the user has the right to use the resource, and
when it is determined that the user has the right to use the resource, the shared service means provides the resource for the application.

20. The information processing program according to claim 11, wherein
the application includes processing information representing logic for executing the application process unique to each application, and an interface used when an apparatus other than the information processing apparatus is used upon the execution of the process by the processing information.
